(19) United States
(12) Patent Application Publication
(10) Pub. No.: US 2004/0249688 A1
(43) Pub. Date: Dec. 9, 2004

(54) Global Integrated improvement planning tool

(76) Inventors: Elizabeth F. Sanders, Houston, TX (US); Rodger L. Fields, Houston, TX (US)

Correspondence Address: EXXONMOBIL CHEMICAL COMPANY, P O BOX 2149, BAYTOWN, TX, 77522-2149, US

(21) Appl. No.: 10/457,343

(22) Filed: Jun. 9, 2003

(51) Int. Cl. G06F 17/60

(52) U.S. Cl. 705/7

(57) ABSTRACT

A tool which gathers relevant improvement data at each particular plant location, for each particular technology and line. This improvement data can be the various underlying data needed for analysis and can include the intended or estimated efficiency increase for given areas of effort, with the relevant costs, manpower and so on. When all of the data for the relevant plants around the world has been inputted, this information is then transferred to a global storage location so that all data from all plants can be accessed simultaneously. With this multi-line, multi-facility data available, reporting structures are developed to allow simplified analysis of the particular improvements and related costs, resources and other factors. Reporting results can be easily developed along a myriad of relationships, such as by geography, by technology, by resource, and so on. Reviewing the derived report selections, at various levels of detail as desired, of all of the facilities around the world, an analyst can readily determine the optimal use of capital and resources to improve overall global system efficiency.

### BACKGROUND OF THE INVENTION

1. Field of the Invention

The present invention relates to a system and method to improve business performance, in particular, to a system and method to identify deficiencies in business processes, provide directions to eliminate such deficiencies, forecast the cost and benefits, and monitor the results from the improvement.

2. Description of the Related Art

In the current economy efficiency is becoming increasingly more important. Both capital expenses and ongoing price pressures have put extreme importance on optimizing efficiency of every process. Adding further complications to this is the general trend toward businesses becoming global in scope, moving plants and materials to low cost labor points, low cost material points, low cost plant development costs or other low cost locations.

While there have been tools to help provide improvement planning for particular individual plants, these tools have helped improve efficiencies only of those particular plants or lines of the particular plant. Various input information has been provided relative to certain physical operations of the particular plant or line. Selected reports for the plant or line recap this information. The recap allowed the possibility of skilled individuals determining allocation of capital expenditures to obtain improved efficiencies for the particular plant and/or line in interest. However, as noted above, globalization is an ongoing and ever increasing fact of modern business and results in many complicating factors. Of most interest to the present invention is the fact that as plants and lines proliferate around the world, it is no longer possible to perform analysis of processes improvement to best use capital and/or resources on a global basis. While the tools for individual plants or lines are available, they are not helpful in the globalization environment because the outputs are simply not usable given the radically increased number of factors and overall amount of data to be analyzed when the analyzer considers the multiple plant, multiple technology and multiple line globalization factor.

Therefore, it would be desirable to have a tool or method of allowing global integrated improvement planning based on data from each particular plant. It is desirable that it would be possible to optimize capital expenditures and resource allocations with only minimal complexity and required time. Further, it would be desirable if the particular reporting used in this optimal analysis could be flexible to better improve analysis of particular tradeoffs needed to reach an optimal allocation.

### BRIEF SUMMARY OF THE INVENTION

A tool according to the present invention gathers relevant improvement data at each particular plant location, for each particular technology and line. This improvement data can be the various underlying data needed for analysis and can include the intended or estimated efficiency increase for given areas of effort, with the relevant costs, workforce staffing (manpower) and so on. When all of the data for the relevant plants around the world has been inputted, this information is then transferred to a global storage location so that all data from all plants can be accessed simultaneously. With this multi-line, multi-facility data available, reporting structures are developed to allow simplified analysis of the particular improvements and related costs, resources and other factors. Reporting results can be easily developed along a myriad of relationships, such as by geography, by technology, by resource, and so on. Reviewing the derived report selections, at various levels of detail as desired, of all of the facilities around the world, an analyst can readily determine the optimal use of capital and resources to improve overall global system efficiency. Thus it is possible with the new tool to perform analyses and develop results which would not otherwise be available based on the prior existing operations and tools.

### BRIEF DESCRIPTION OF THE SEVERAL VIEWS OF THE DRAWINGS

FIG. 1 is a map of the world with representations of selected plants and technologies in the particular plants to illustrate examples of the plants, technologies and lines to be improved according to the present invention.

FIG. 2 is a diagram illustrating the data flow and reporting of a tool according to the present invention.

FIGS. 3A and 3B are a representation of a first hierarchical structure of data used in a tool according to the present invention.

FIG. 4 is a representation of a second hierarchical structure of data used in a tool according to the present invention.

FIG. 5 is a screen shot of an opening data entry screen of a tool according to the present invention.

FIG. 6 is a screen shot of a first detailed data entry screen of a tool according to the present invention.

FIG. 7 is a screen shot of a second detailed data entry screen of a tool according to the present invention.

FIG. 8 is a screen shot of a third detailed data entry screen of a tool according to the present invention.

FIG. 9a is a screen shot of a data entry screen for planned benefits to be gained by particular improvements in a tool according to the present invention.

FIGS. 9b and 9c are screen shots of alternatives of the planned benefits screen of FIG. 9a.

FIG. 10 is a screen shot of a data entry screen for resource allocation in a tool according to the present invention.

FIG. 11 is a screen shot of a data entry screen for providing particular data related to a particular line and/or technology of interest in a tool according to the present invention.

FIG. 12 is a screen shot of a data entry screen for planned improvement levels according to defined potential criteria in a tool according to the present invention.

FIG. 13 is a screen shot of a data entry screen providing information on uneconomic portions of the particular gaps between the improvement levels in the particular technology and/or line of interest in a tool according to the present invention.

FIG. 14 is a screen shot showing a local report of facility data provided by data entry into the prior screen shots in a tool according to the present invention.

FIG. 15 is a screen shot showing an alternative way of displaying the calculated gap information for locally provided data in a tool according to the present invention.

FIG. 16 is a screen shot of a local report illustrating the gaps between improvement levels in a tool according to the present invention.

FIG. 17 is a screen shot of a report showing data to be provided for a Pareto analysis of local data in a tool according to the present invention.

FIG. 18 is a screen shot of a local report indicating improvement levels, parameters and gaps in a particular technology or line in a tool according to the present invention.

FIG. 19 is a screen shot of an initial report selection screen for selection of global data to be analyzed in a tool according to the present invention.

FIG. 20 is a screen shot of a report information selection screen to allow simple selection of criteria to allow analysis of the improvement planning information provided in a global basis in a tool according to the present invention.

FIGS. 21a and 21b are screen shots of a chart information selection screen to allow simple selection of criteria to allow analysis of the improvement planning information provided on a global basis in a tool according to the present invention and a resulting chart of curve data.

FIGS. 22a, 22b and 22c are screen shots of selection criteria and charts of the selected data illustrating gap closure by performance category and by site.

FIGS. 23a and 23b are screen shots of selection criteria and a chart of the selected data illustrating gaps versus closure plans

FIGS. 24a and 24b are screen shots of selection criteria and a chart of the selected data illustrating a Pareto chart of gaps by performance category.

FIGS. 25a and 25b are a screen shot of selection criteria and a portion of a report of the selected data illustrating the selected projects by plant, by year, with total estimated costs for each year.

FIGS. 26a and 26b are a screen shot of selection criteria and a portion of a report of the selected data illustrating the selected projects by plant, by year and by percent discounted cash flow (% DCF).

FIGS. 27a and 27b are a screen shot of selection criteria and a portion of a report of the selected data illustrating the selected projects by plant and by % DCF.

### DETAILED DESCRIPTION OF PREFERRED EMBODIMENT

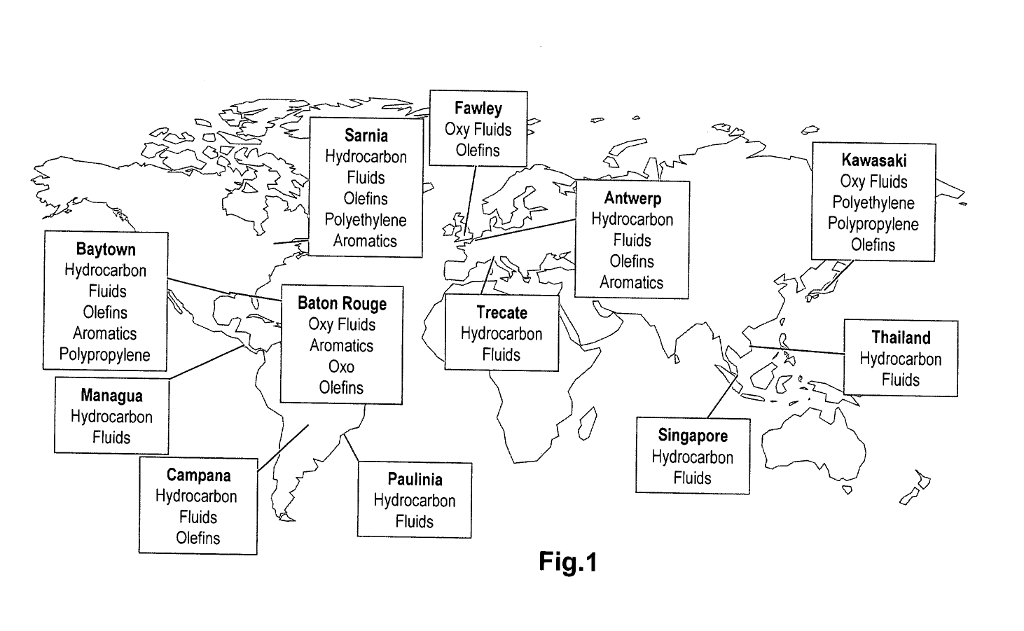

Proceeding then to FIG. 1, a map of the world is shown. On this map are various boxes which indicate particular plants around the world and particular technologies and/or lines present at that particular plant. In the preferred embodiment the optimization or improvement planning process is practiced on a series of chemical plants, many of the plants having a variety of different technologies and/or lines to develop specific chemicals. Exemplary chemical families developed in the plants are shown in FIG. 1. While the preferred embodiment described herein is developed for optimizing improvements in processes of chemical plants, it is understood that many other applications of the systems and tools according to the present invention can also be developed. Examples of additional uses would be any repetitive manufacturing or construction process and item or material flow situations.

As can be seen in FIG. 1, there are numerous plants scattered over the world, with various technologies among the plants. There is no uniform mapping of technologies to particular plants. Rather the set of plants for each technology is different. For example, three of the plants, namely, Baton Rouge, Fawley and Kawasaki include lines relating to oxy fluids, whereas nine plants include hydrocarbon fluids, none of the nine plants also making oxy fluids. In other cases particular of the plants include olefins but others do not and so on as can be seen by reference to the blocks on FIG. 1. Thus, while it would be relatively straightforward to do optimal improvement planning for a particular individual plant, by the time the numerous plants around the world and the unmatched combinations of particular technologies within particular plants is noted, the number of variables and sheer amount of data is beyond simple comprehension according to the prior single plant models or tools.

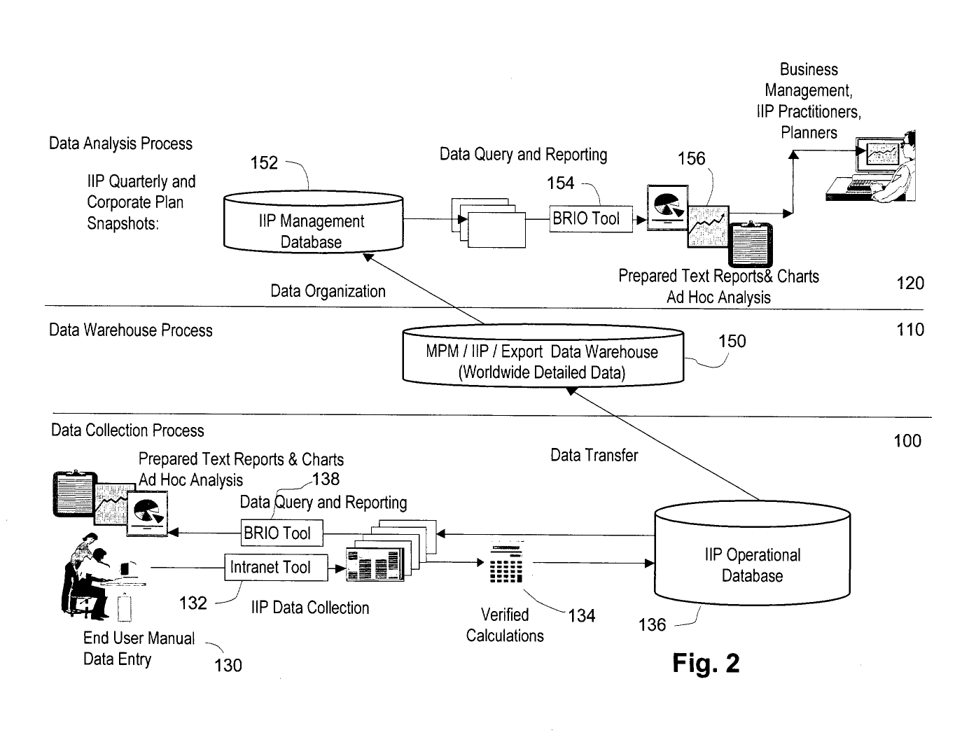

Referring then to FIG. 2, a computer organization according to the preferred embodiment is shown. FIG. 2 is divided into three sections, 100, 110 and 120. Section 100 is a data collection process and occurs at each particular plant for each particular technology and/or line. Section 110 is a data warehouse process and it occurs at one centralized location, which may of course be replicated. Section 120 is a global data analysis process which occurs at the desired locations that are performing the actual global planning and management functions.

Referring then to section 100, the data collection process, a series of users provide manual data entry 130. Preferably the users enter data into an intranet tool 132, screen shots of which are shown in the following figures. This data is then collected from the intranet tool. Any calculations needed to develop additional data values are performed by calculation entities 134 from the input data and provided to the local database 136. To aid in the global nature of this tool, the calculation entities 134 provide uniformity. There is a local operational database 136 for each particular plant, at least in a logical arrangement, so that data entry is done on a local basis by operators and users familiar with the details of the particular plant. As noted, examples of the data entry are shown in numerous screen shots in following figures. It is also possible to do querying and reporting 138 on the local operational database 136. In the preferred embodiment a series of tools referred to as Brio tools, such as the SQL (Brio Reports™) tools from Brio Software™, are used in developing both local and global data reporting and charting. While this is the preferred tool, it is understood that various other data query and reporting tools which can properly interface with the relevant database can be utilized. The output of the Brio tools 138 is a series of reports and charts 140 to show the local users that the data has been properly entered and potentially to do local plant processes improvement analysis.

On a periodic basis, in the preferred embodiment daily, the data from each of the local operational databases 136 around the world is uploaded to a centralized data warehouse 150. In this manner on a periodic basis all of the data which has been entered by the particular users around the world can be obtained and integrated into a single large database. However, while any changed data is uploaded daily, in practice the data is changed much less frequently, typically five to six times a year based on the normal processes of the organization.

The global data analysis process in section 120 on an occasional basis transfers the desired process improvement data from the data warehouse 150 to a management database 152. As with the local data, any changed data is uploaded daily but only used on a quarterly basis or when global corporate plans are being developed. The data could be referenced directly from the data warehouse 150, but the use of the management database 152 is preferred for performance and security reasons. Preferably the data contained in the management database 152 is all of the data obtained from the series of local operational databases 136, so that all available data (or selected portion thereof) is present to do a full global analysis. In the preferred embodiment the Brio tools mentioned above are utilized as Brio tools 154 to do data query and reporting on the captured snapshots of the process improvement data. The Brio tools 154 are utilized to prepare various reports and charts 156. These reports and charts 156 are then utilized by the various business management, individuals and process improvement planners to determine the optimal use of limited available resources such as capital and manpower to provide an optimal process improvement on a global nature.

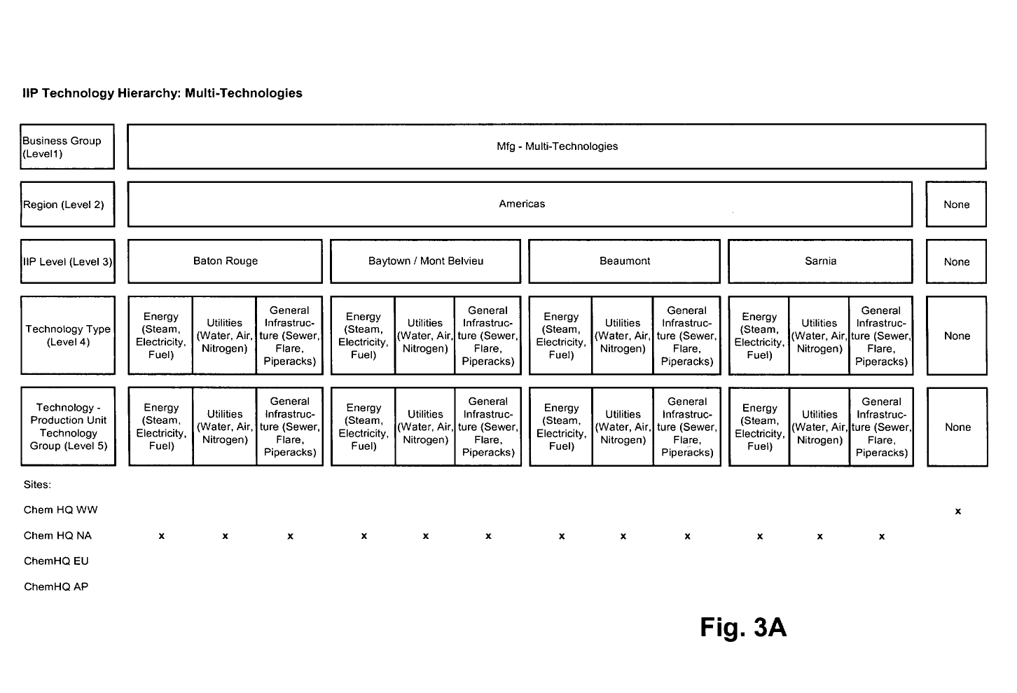

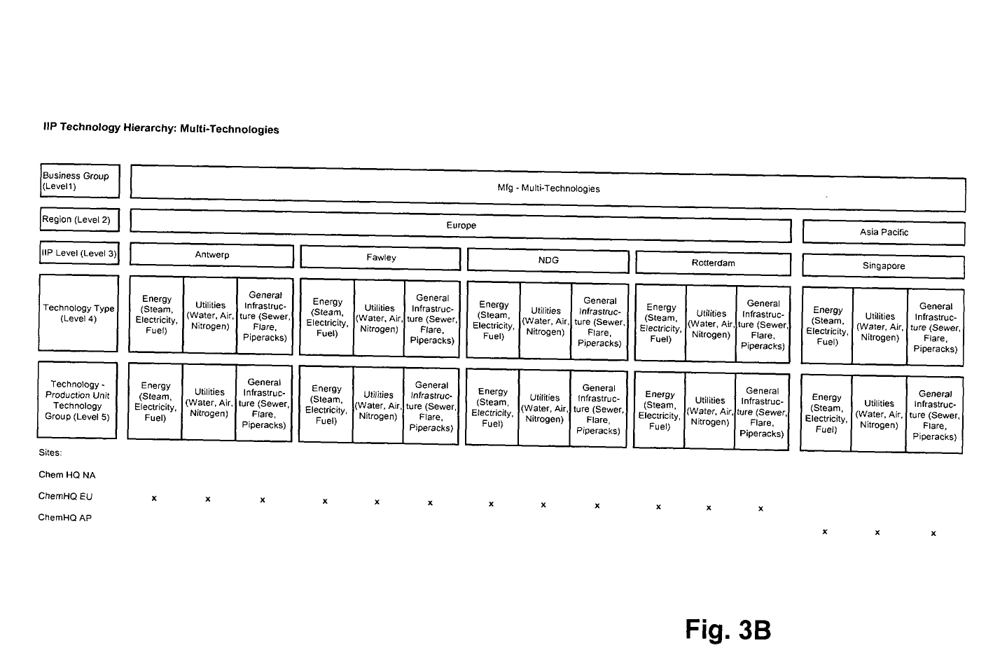

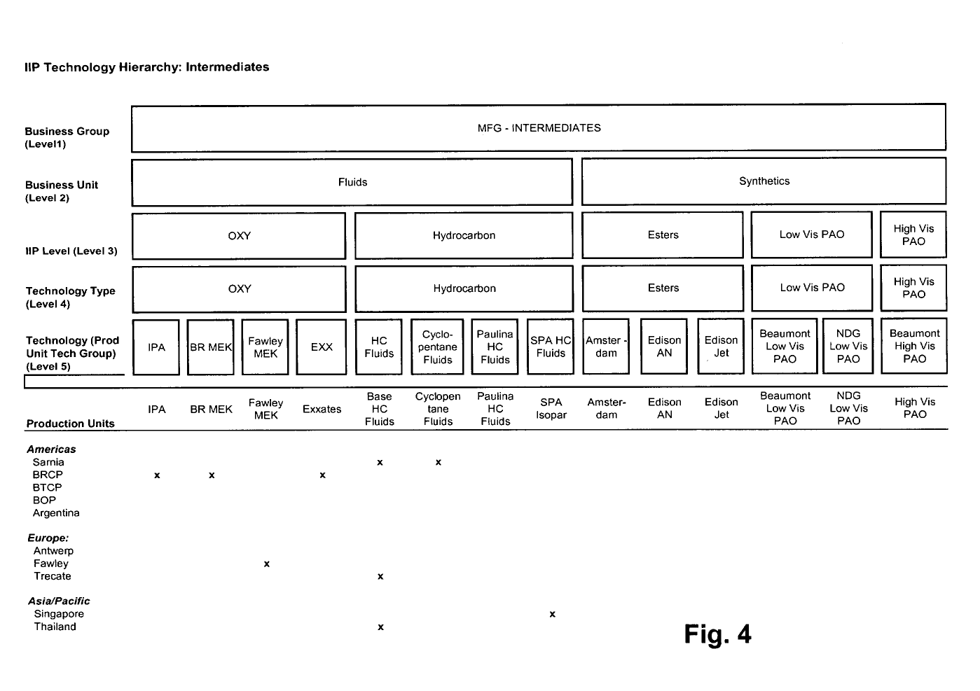

One advantage of the organization and arrangement of the process improvement data in the management database 152 is that it can be viewed and organized in a number of different fashions to aid analysis and planning. For example, FIGS. 3A and 3B are a representational organization by geography at the highest levels and down to technology types and production units. This is a first way of cutting or viewing the data. FIG. 4 is an alternative way of viewing the data in the indicated example from the particular product type, such as intermediates, then fluids and synthetics, and so on and ending up at the most detailed level with the particular plants and lines. Thus optimization can be readily easily perceived using either a location or a technology original focus.

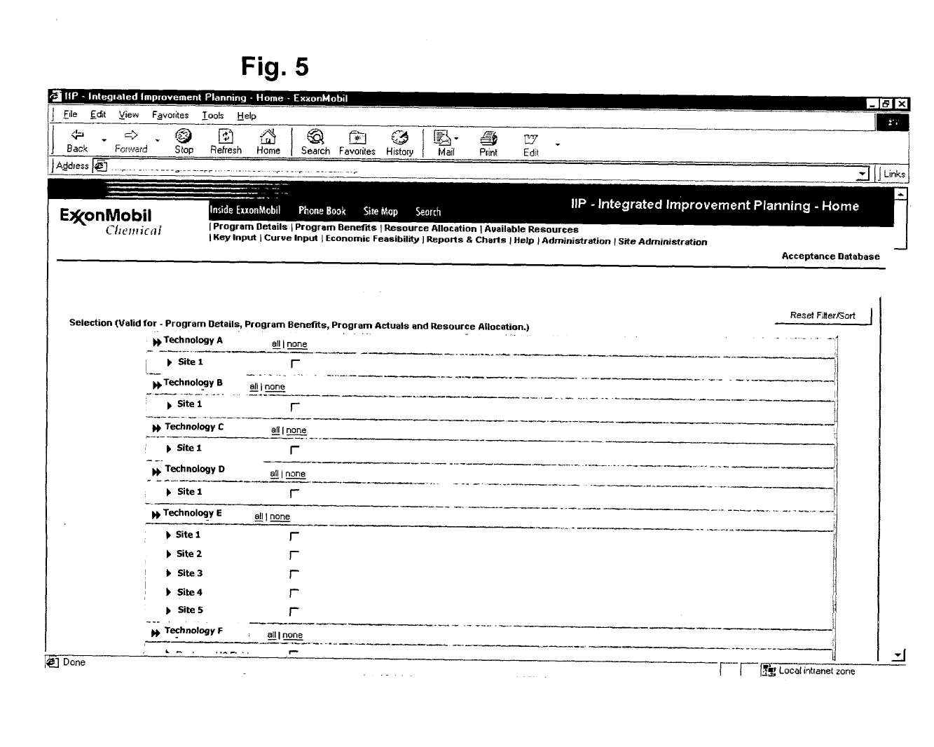

To allow the tools to be utilized and the process to commence, data must be input into each local operational database 136. The first entry screen to provide this capability is shown in FIG. 5. When a particular data entry individual logs onto the particular program, a screen similar to that shown in FIG. 5 is provided. In the particular embodiment as shown in FIG. 5, a number of different technologies and locations are shown for illustrative purposes. In practice it is preferred that only the particular plant and/or lines relevant to that particular data entry individual are shown on the screen. Thus, for example, if it is a single operator in the Baytown facility and the operator is only familiar with aromatics, then only that particular entry type would show in the data entry screen of FIG. 5. In the alternative, if the individual was located in Antwerp and has broader data entry authority, then this person could enter hydrocarbon fluids, olefins and aromatics information. So additional entries such as shown in FIG. 5 would be present on the initial screen.

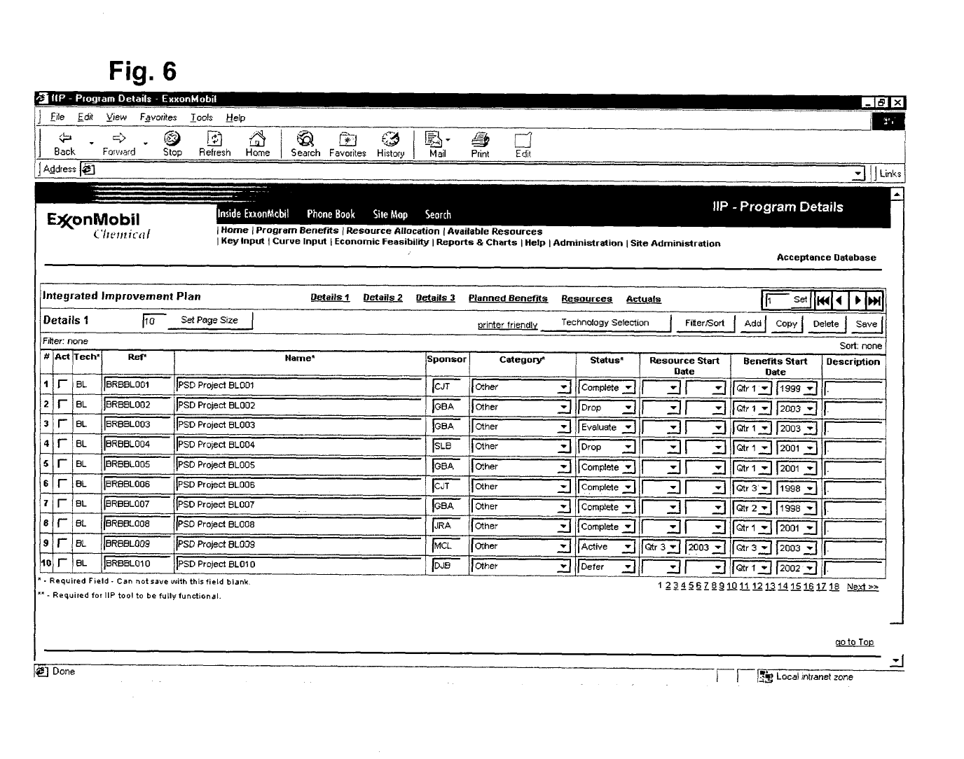

The operator selects the desired plant and/or line for data entry on the screen of FIG. 5. After the particular desired location is indicated, the screen shown in FIG. 6, the first detail screen, is shown. Various identification information is provided, such as an autogenerated reference number; the entered name for the particular process improvement which is to occur; the sponsor of the improvement; the category of the improvement; the improvement status, such as completed, deferred, and active; when the improvement is to start development; and when the benefits are to start occurring. This, of course, is exemplary information and other information could be desired depending upon the particular improvement and environment.

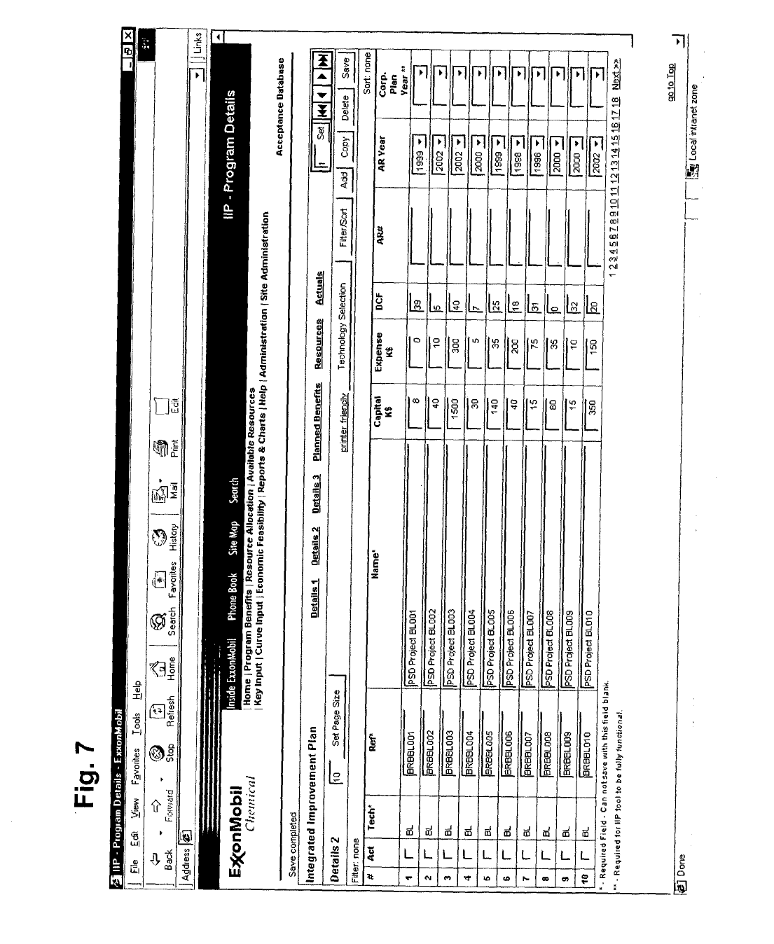

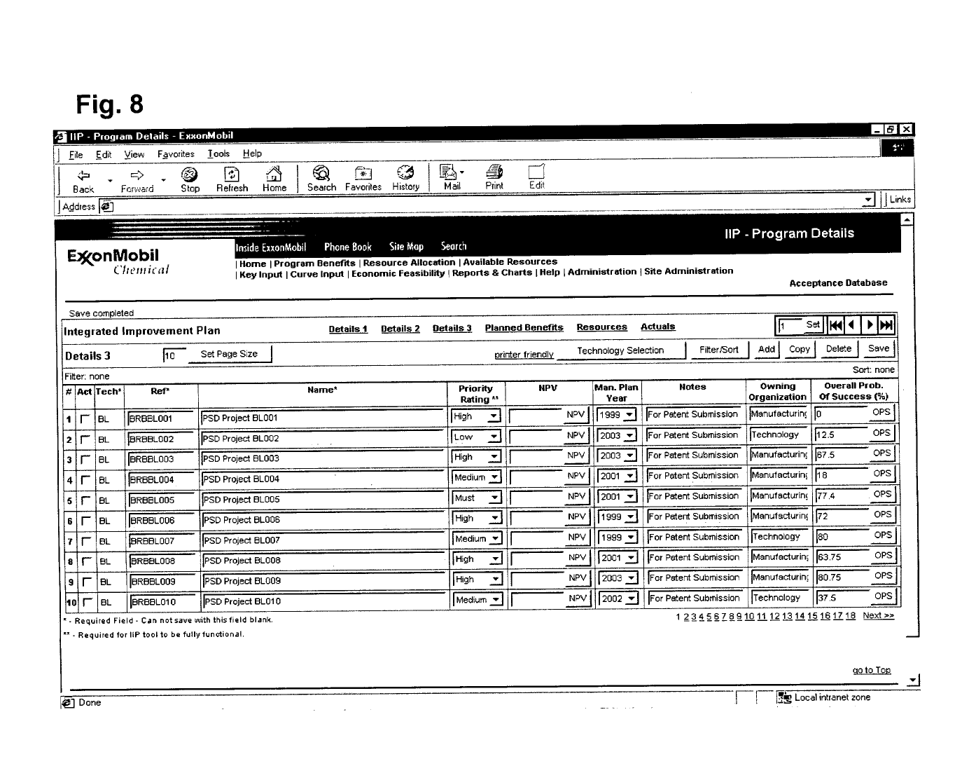

With data entry completed on the details one page of FIG. 6, then the details two page of FIG. 7 is displayed and that particular information is entered. For example, for a particular indicated reference number and name indicating a particular improvement, the capital and expense dollars necessary for the improvement would be indicated, with the particular plan year, for example into which year the expenditures would occur are provided. A details three page is then used as shown in FIG. 8 to provide further information or the particular improvement, such as its priority and other relevant information. Alternatively, all of these details could be provided in one screen, but three screens were preferred to simplify the screen design.

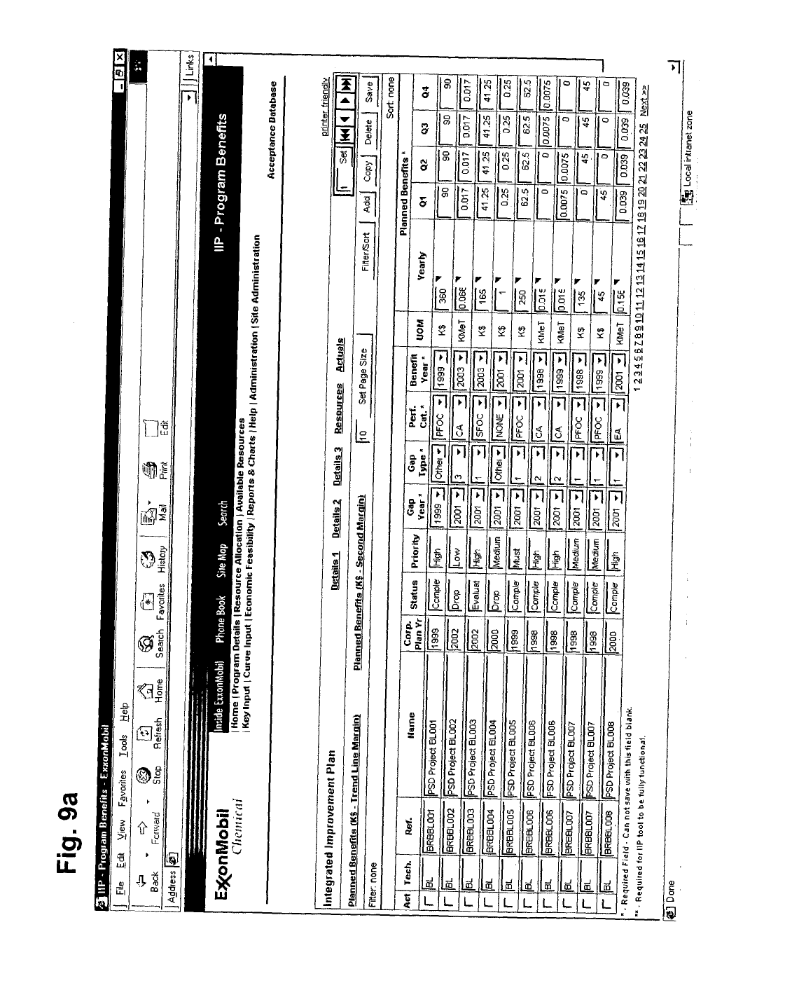

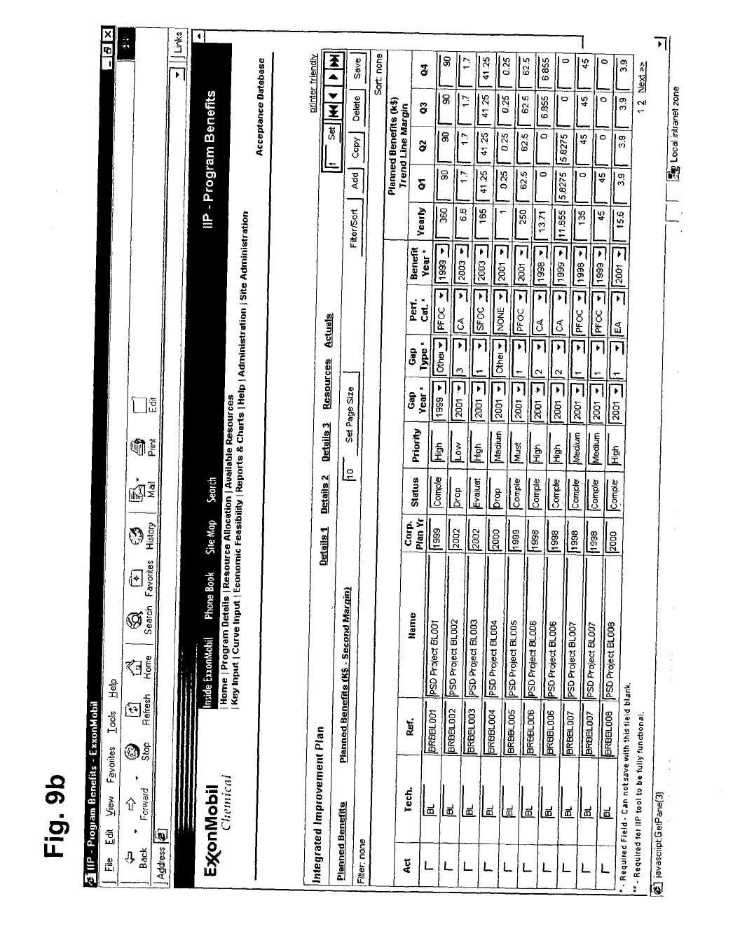

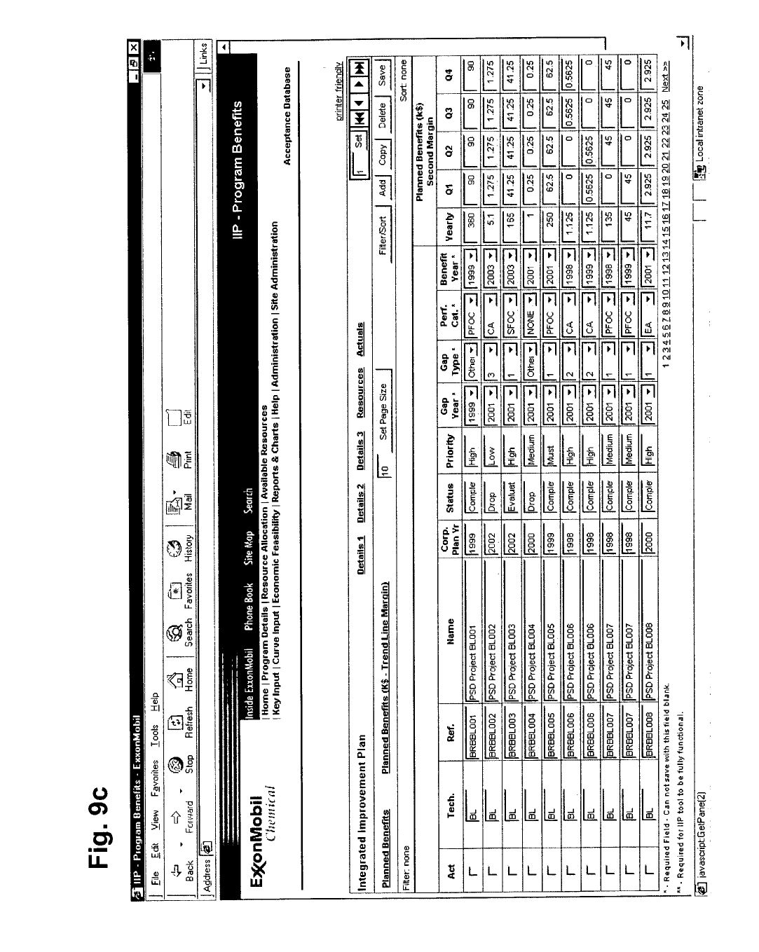

After all of the details have been entered, data relating to certain planned benefit information is provided as shown in FIG. 9a. For example, this would include the year when a particular gap in efficiency is relevant; the performance category, such as raw materials, operating costs and capacity availability; and the year in which the benefits are to be obtained. As can be seen in FIG. 9a, in the preferred embodiment a series of plan benefit entries for the particular year, preferably on a quarterly basis, is provided to start populating these entries for this particular process improvement. It is noted that this is be done for each of the multiple years if the benefits develop over a number of years. It is also noted that there can be multiple performance categories for each process improvement, so an additional dimension of the data is available if needed.

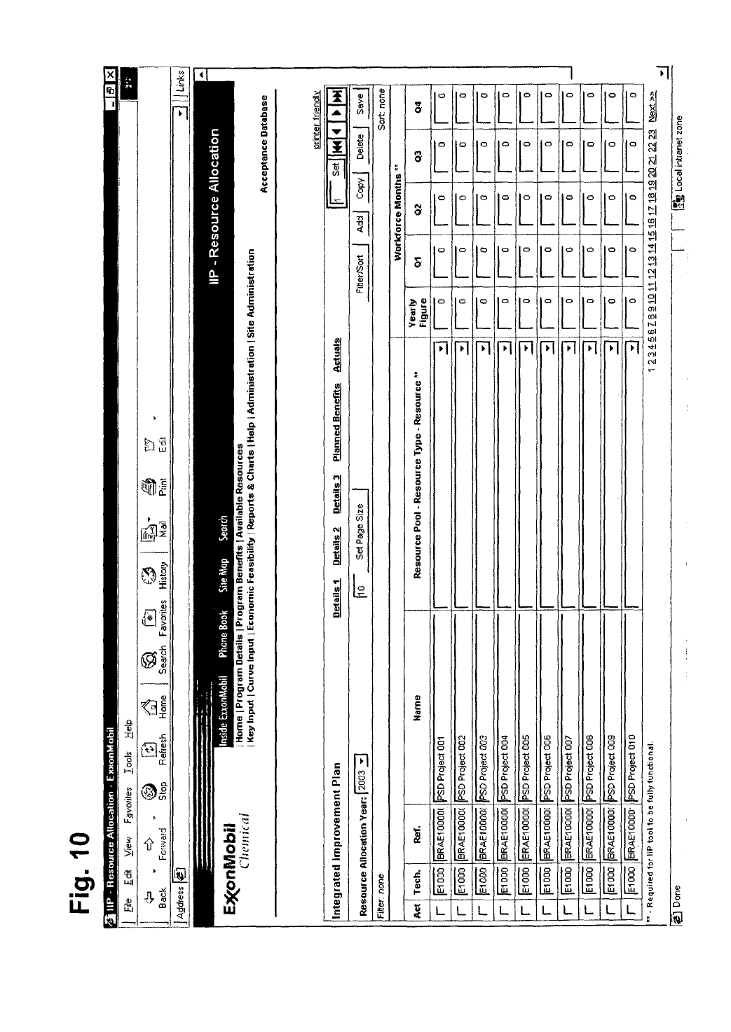

With the benefits entered, it is appropriate to enter the resources (e.g., workforce staffing) required to develop the improvements. This is entered in a screen similar to that shown in FIG. 10. In the preferred embodiment resource pools, which can be down to the level of individuals, are provided and allocated to a particular process improvement. As shown in FIG. 10, preferably the data provided for each process improvement would include the particular man months needed to perform the operation. This allows resource planning to be developed as part of the overall optimization process for the improvements.

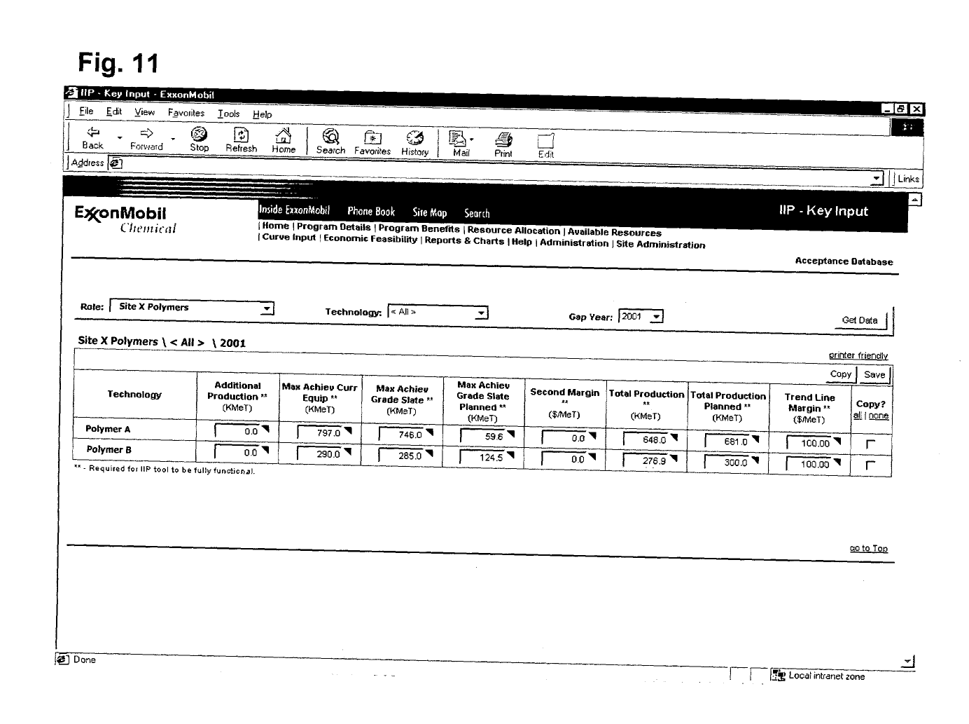

When the necessary resources have been provided, the particular key input is recorded as shown in FIG. 11. For the preferred embodiment of chemical plant process improvement, various bases for production information can be provided. Other data can be provided as needed to do optimal planning.

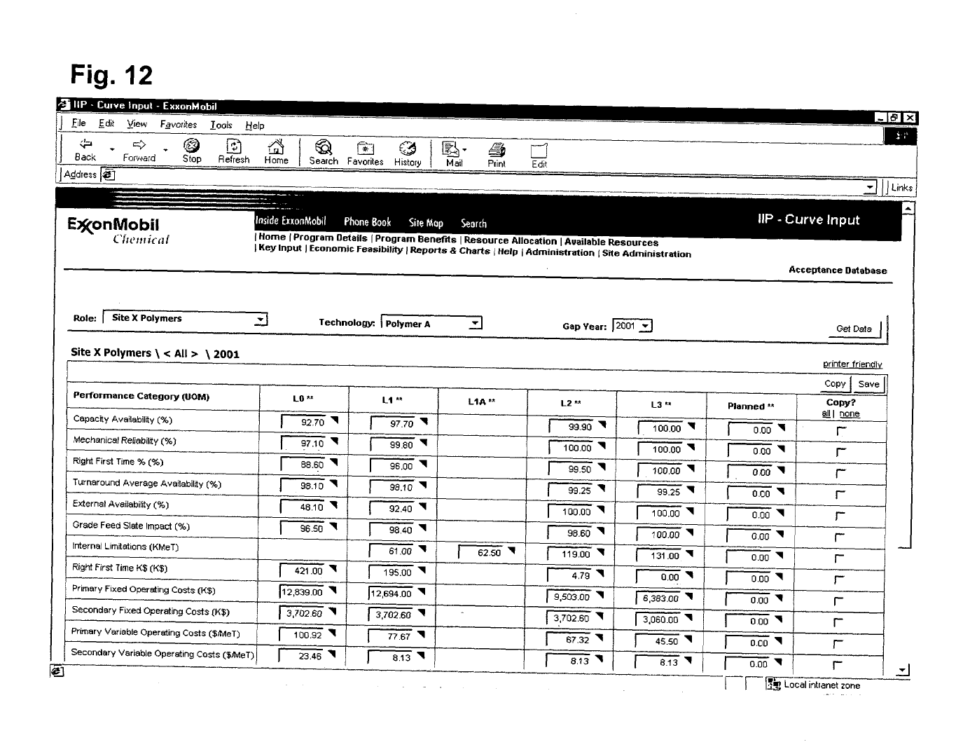

Then, as shown in FIG. 12, the particular curve data is entered. In this discussion curve data relates to the improvements that can be made according to four different improvement levels. A first column L0 is present, indicating particular metrics to be improved. L0 is the actual prior year value of each metric of the process with particular availabilities, reliabilities, and so on. Preferably certain metrics are provided as a percentage, a dollar amount or a dollar per unit volume. The second improvement level or column is referred to as the L1 value. In the preferred embodiment L1 is the best case performance which has occurred for the particular line or technology in that particular plant or at a comparable line or technology at other company plants. In some cases an L1A value is provided. This is an alternative L1 value which can be used in any calculations to cover the instances where a small investment can be made to remove a process bottleneck or production limitation. The next column or improvement level which is relevant is an L2 value, which is the relevant value for a best in the industry deployment. This may be the particular line of interest or it can be an equivalent line in a competing alternate plant or a line in a competing company. The final column of improvement level is the L3 column, which is the theoretical maximum efficiency or improvement of the particular process. Thus a curve set is provided from last year to best internal to best in industry to theoretical maximum.

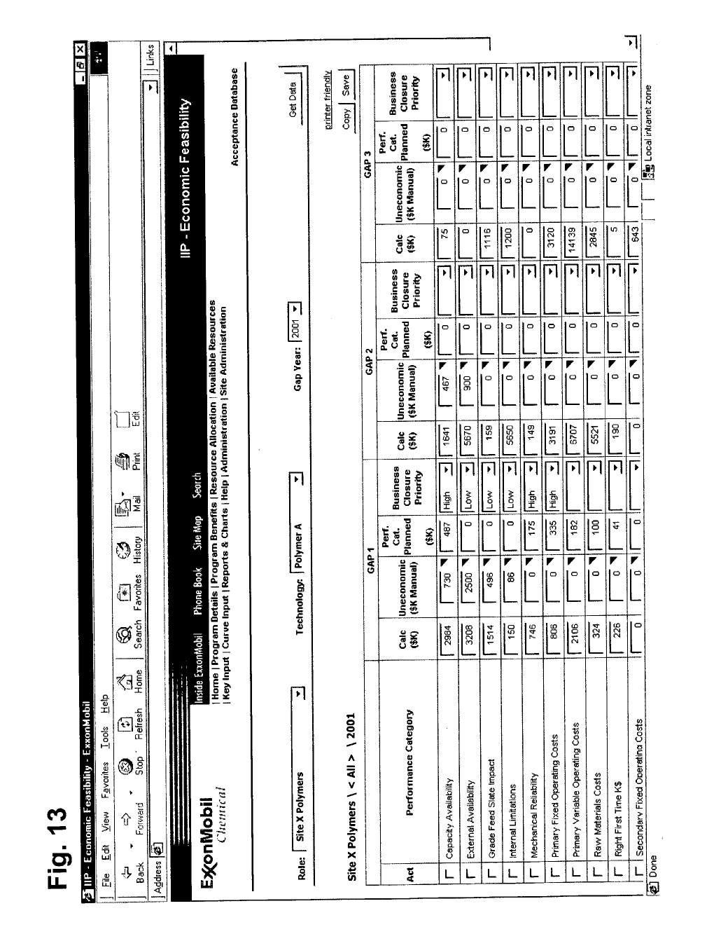

As shown in FIG. 13, it is also understood that in some cases it may not be economically viable to attain the improvement levels defined by the gaps between the various improvement levels. Therefore, manual entries provide uneconomic values for the particular technology and line for which metrics have been entered.

It is noted that the screen shots of FIGS. 6 to 10 illustrate entries for the particular improvements available to the data entry individual across all technologies, FIG. 11 is for entry of the particular technology, for each year, for a plant and FIGS. 12 and 13 are for yearly values for the particular technology, with all of the various planned improvements.

While the above description assumes a flow of data entry, it is possible, and indeed common, to not provide all of the data possible. For example, in many cases resource information can be omitted. Further, the data can generally be entered in various orders after the relevant process improvement is entered.

Should the data entry individual desire to validate any data entry, each of the data input screens preferably includes a printer friendly mode to allow a printed output to be generated and used to compare with any source data.

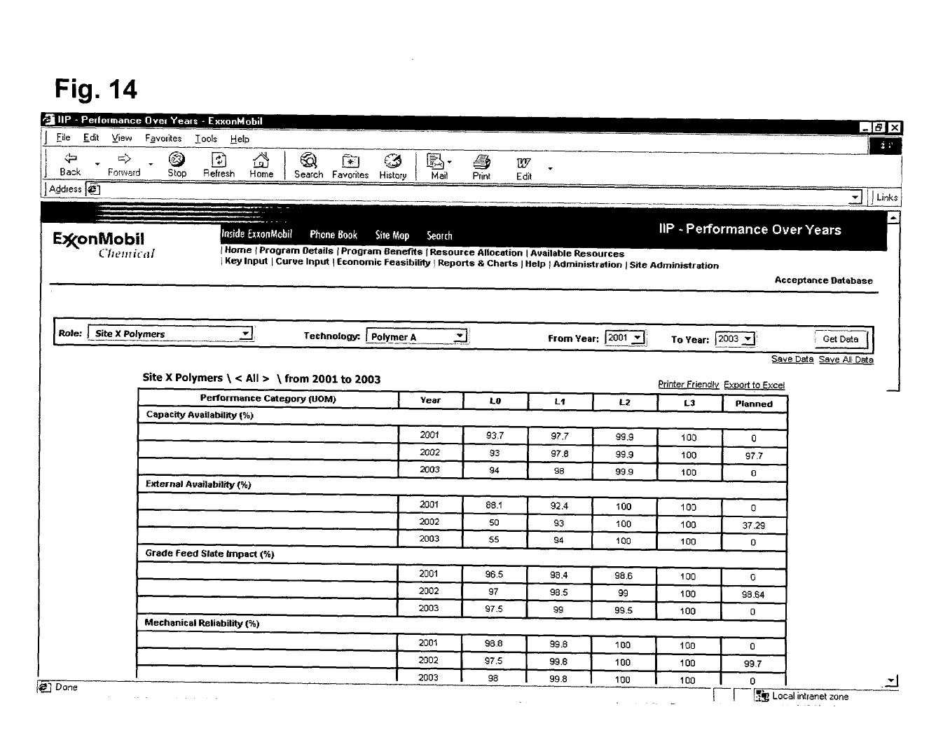

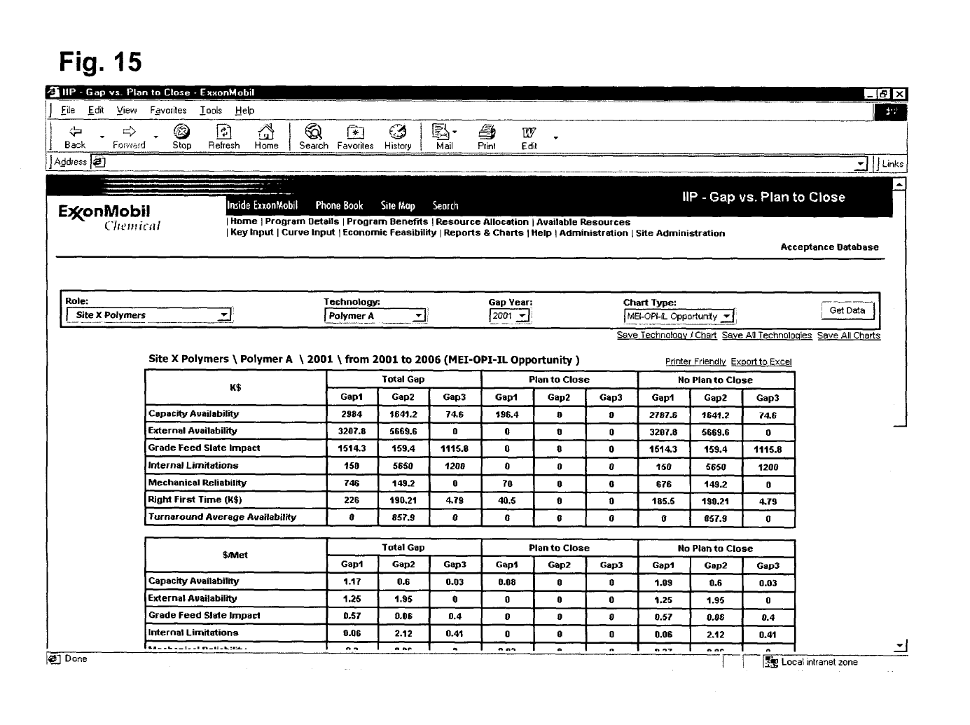

When the data is finally entered, the local user can run a report and provide a screen as shown in FIG. 14. This shows the performance levels, or L0 to L3, of the particular line or technology over a series of years so that data entry can easily be checked. This report can also be used to provide data to be used in various charts used in the optimization process. A second local report would be a gap versus plan to close report as shown in FIG. 15. This reports show the actual gaps between the various levels of L0 to L1, L1 to L2, and L2 to L3 for the particular technology over a selected period. The report further indicates which of the gaps are planned to be closed and which portions of any particular gaps are not planned to be closed, either because they are not economic or their particular process improvements have been deferred. This allows for analysis by the individuals and data verification. The indicated gap values are calculated from the previously entered data. The basic key input values are combined with the curve values, the uneconomic values and the planned process improvement benefits to provide the resulting gap change or improvement values.

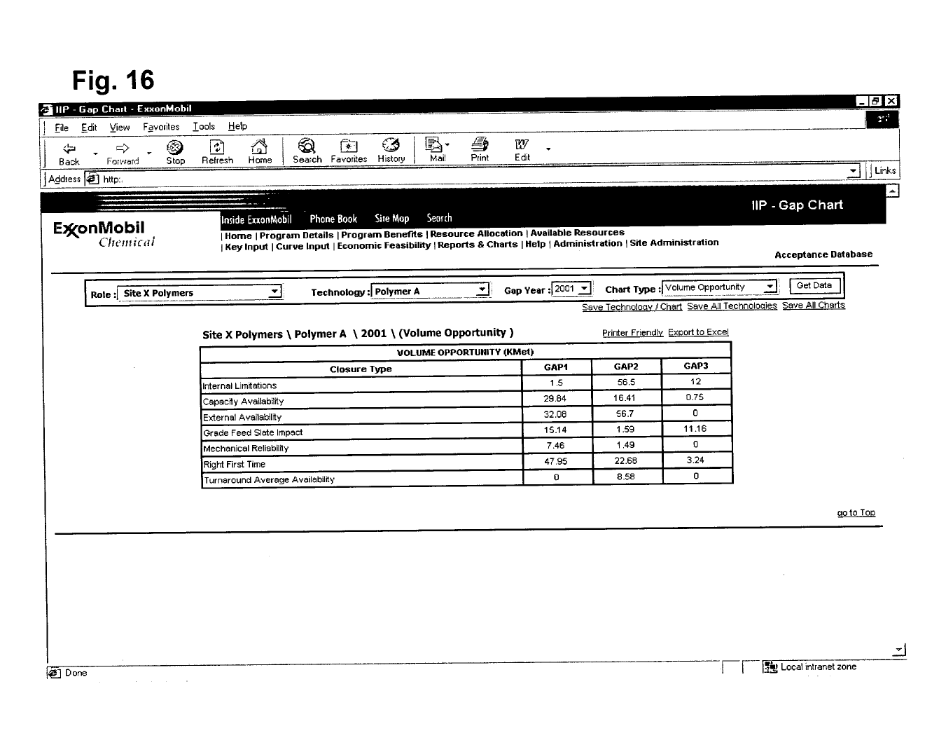

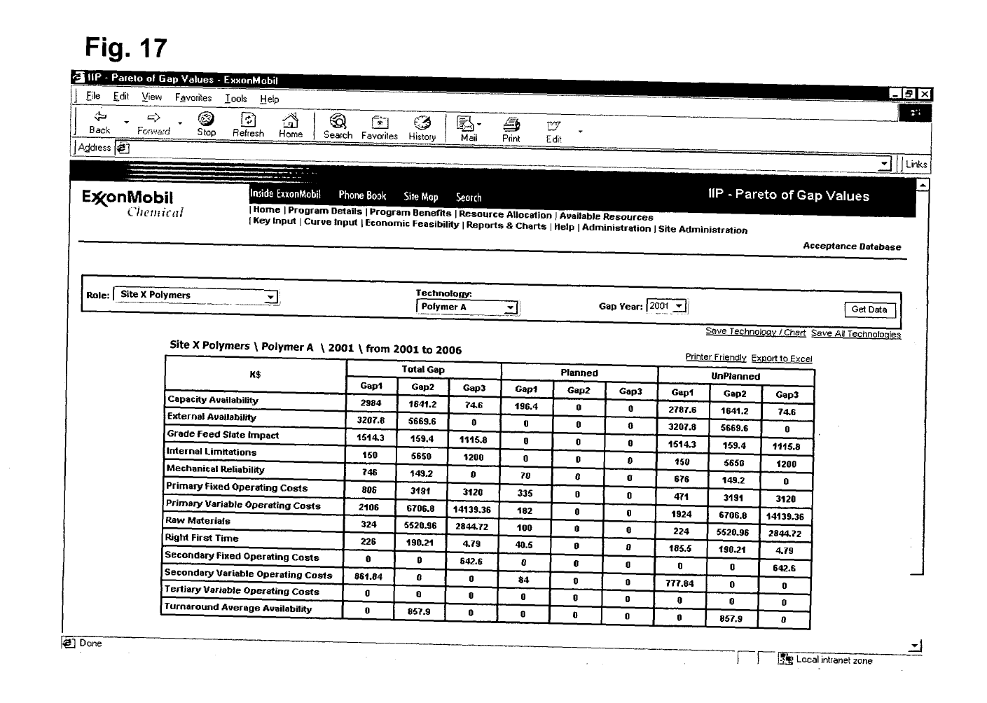

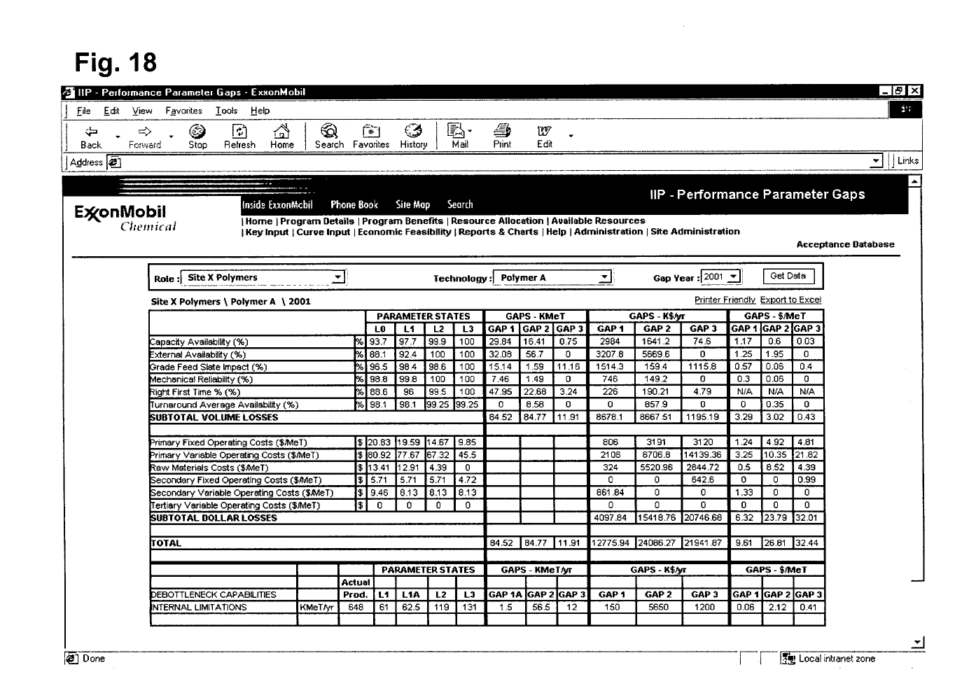

FIG. 16 illustrates a screen shot of an additional local report, which shows particular gaps which can be filled if desired. A Pareto analysis of the various gaps over a time period can be developed using the Brio tools and local database 136, with results provided in a format as shown in FIG. 17. A further local report in the preferred embodiment is shown in FIG. 18. This report is effectively a recap of the various reports to show the various curve data, gaps, dollar values related to those particular gaps and other items for the particular technology for the particular gap year.

Therefore, using the particular data entry screens illustrated and feedback and verification according to the indicated reports, local users enter data for all years, all lines, all process improvements developed, and so on to provide a complete data set into the local operations database 136.

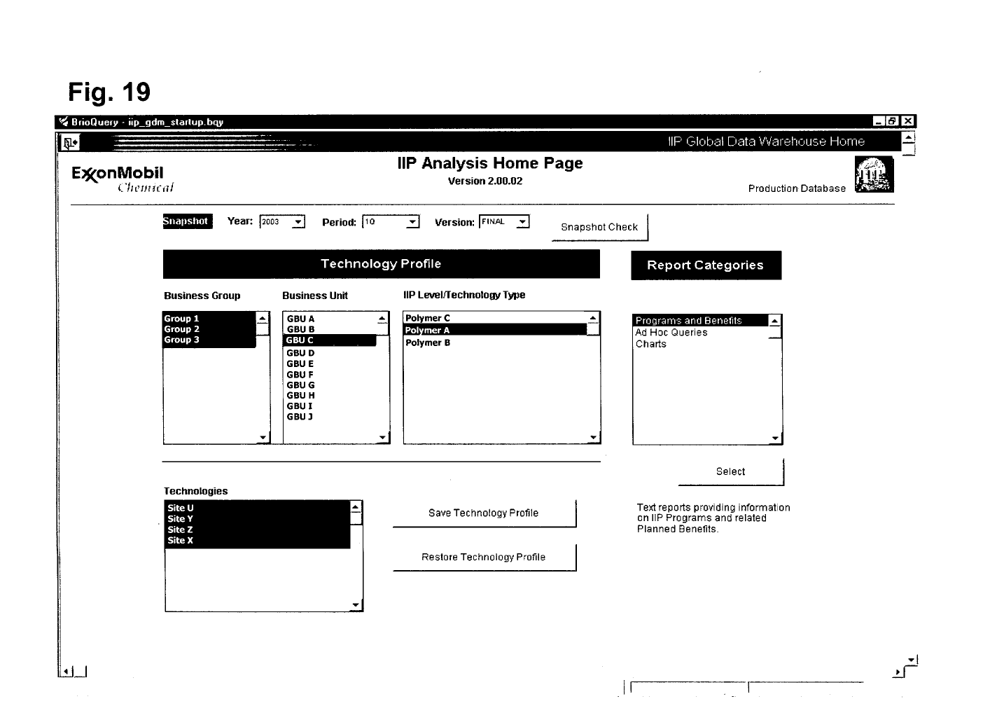

As described previously, these local operation databases are collected into a data warehouse 150, with quarterly or planning time snapshots taken and provided to a management database 152. With global data thus available for analysis, query and reporting of this global data can occur in the preferred embodiment. Referring then to FIG. 19, an opening screen is shown to start the query and/or reporting process. Data to be analyzed can be selected according to the levels shown in FIGS. 3A, 3B and 4. For example as shown in FIG. 19, a technology-based profile is utilized so that the user would first select the business group such as basic chemicals, intermediates, or polymers. With that selection made, then the next lower level down, such as leadership polymers in the indicated figure, or for example using the chart of FIG. 4 with the intermediate source selected as the business group, a business unit of fluids could be selected from a selection of fluids or synthetics. If fluids were selected, a technology type such as oxy fluids or hydrocarbon fluids could be selected. Finally, under this technology profile the particular plants or lines of interest could be selected. It is understood that multiples of these could be selected as well, such as intermediates and polymers, a series of business units, a series of technology types and so on. Thus the selection of the desired data from the available data can be done on a very flexible basis to allow the desired analysis and optimization to occur.

With the data sources selected, a series of predetermined report types can then be utilized. For example, as shown in FIG. 19, the report categories are programs and benefits, ad hoc query, resource balancing, key curve data, administration or various charts.

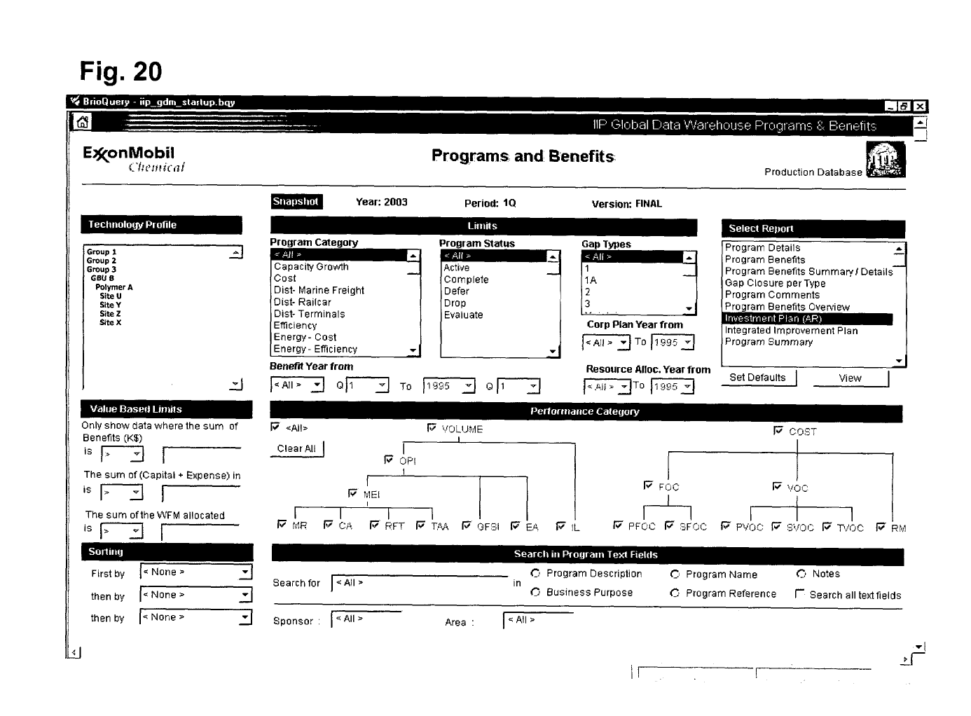

Proceeding then to FIG. 20, it is assumed that a program and benefits report type has been selected. This then leads to the screen shown in FIG. 20. The selected technology profile is indicated in the box 220 on the left hand side. The remainder of the screen is provided for selection of other particular limits, quantities, qualities, parameters that would be applicable to the particular fields that have been utilized in the database. As can be seen this is done in a very graphical and user-friendly manner to further aid and simplify development of data and analysis. Further, the actual report is selected.

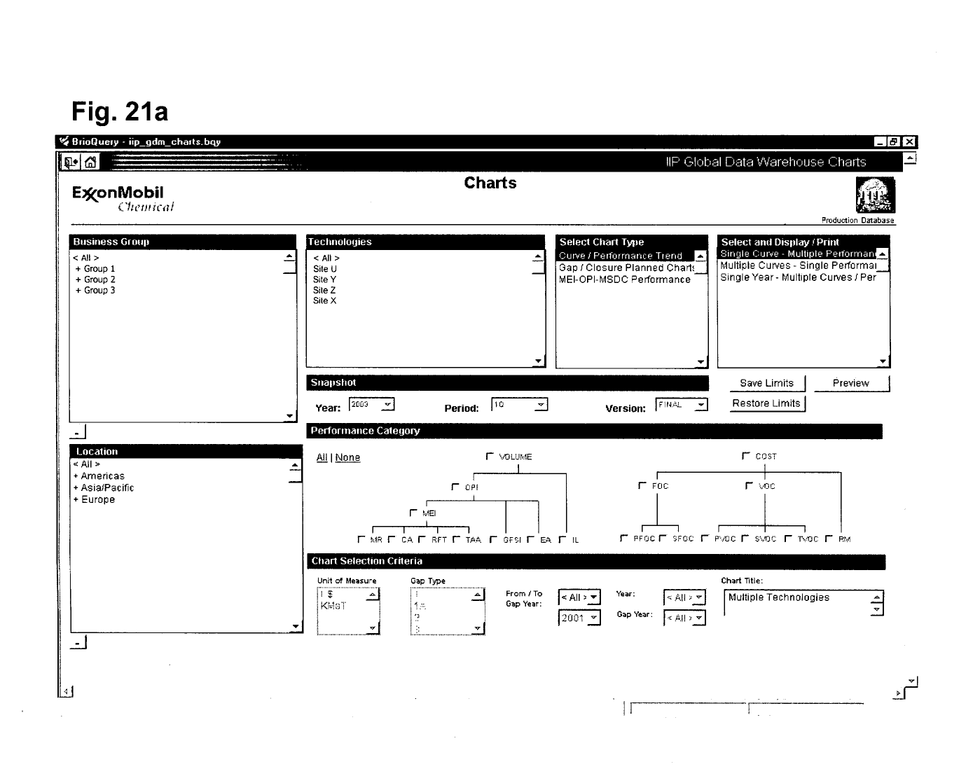

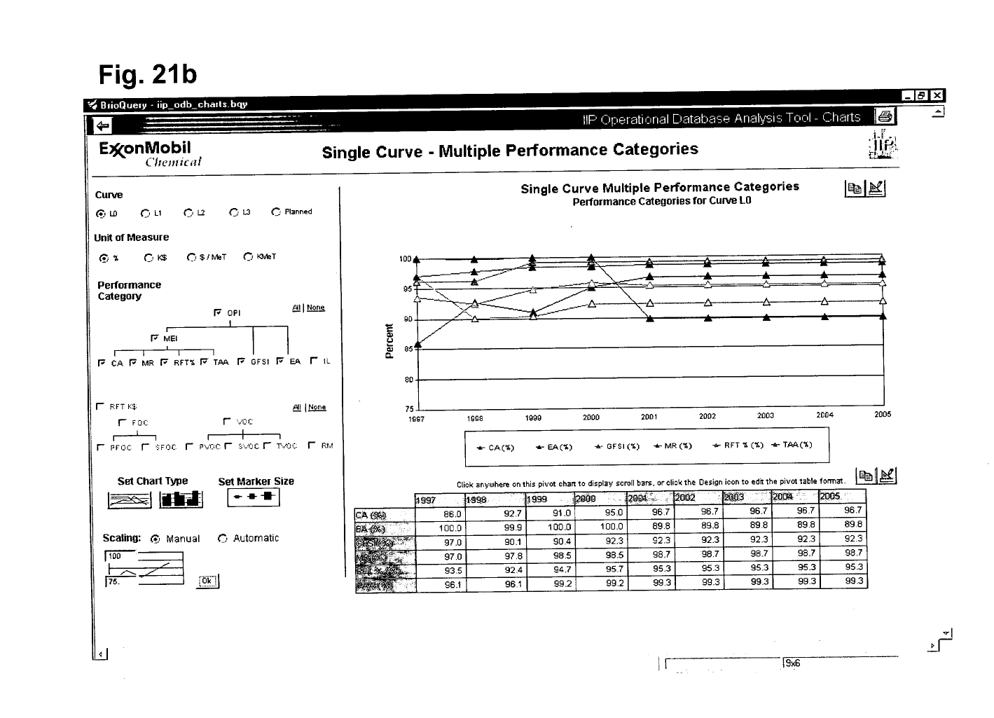

Alternatively, assume that a curve analysis has been requested and that a chart is to be developed. The resulting parameter selection screen is shown in FIG. 21a. One particular chart that can be used to analyze the data to allow quick graphical analysis would be a single curve and multiple performance categories. For example, for a given L0, L1, L2 and so on, L0 as shown in FIG. 21b, a series of performance categories can be illustrated. In the indicated embodiment, the performance categories are shown in a graphical form over a series of years to show results of improvements or changes which have occurred.

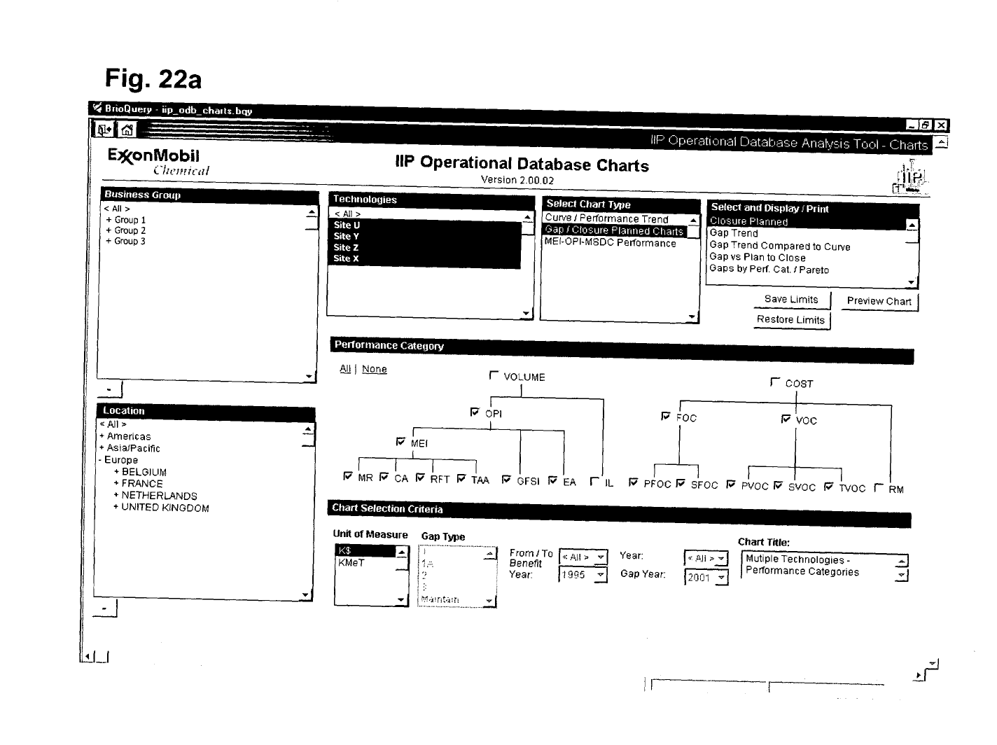

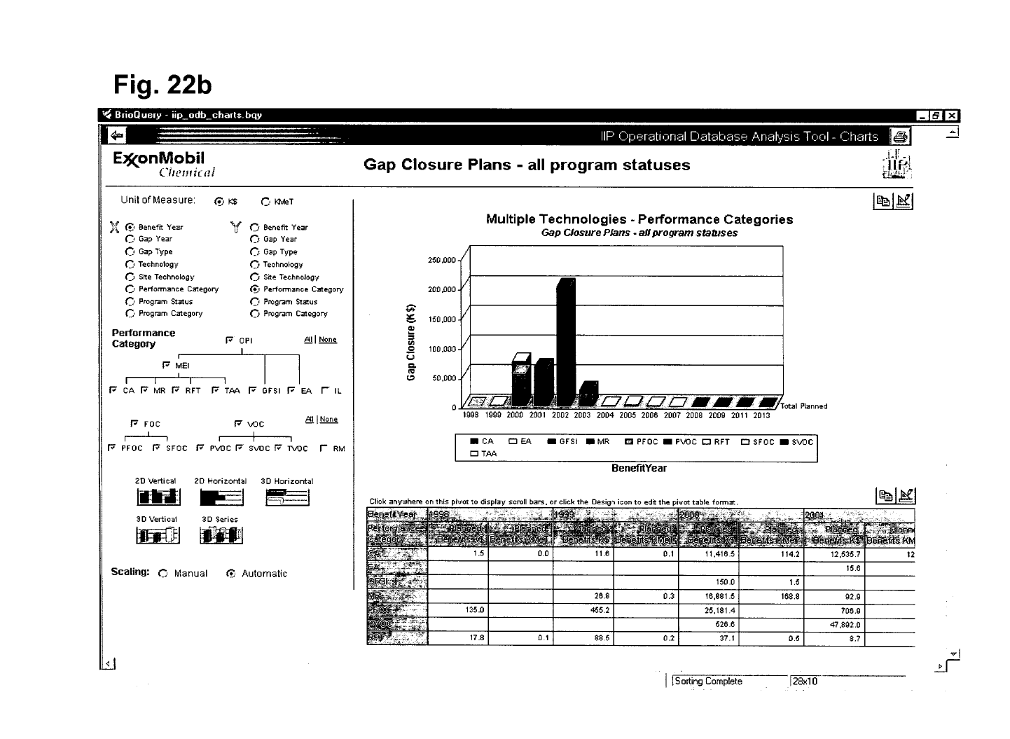

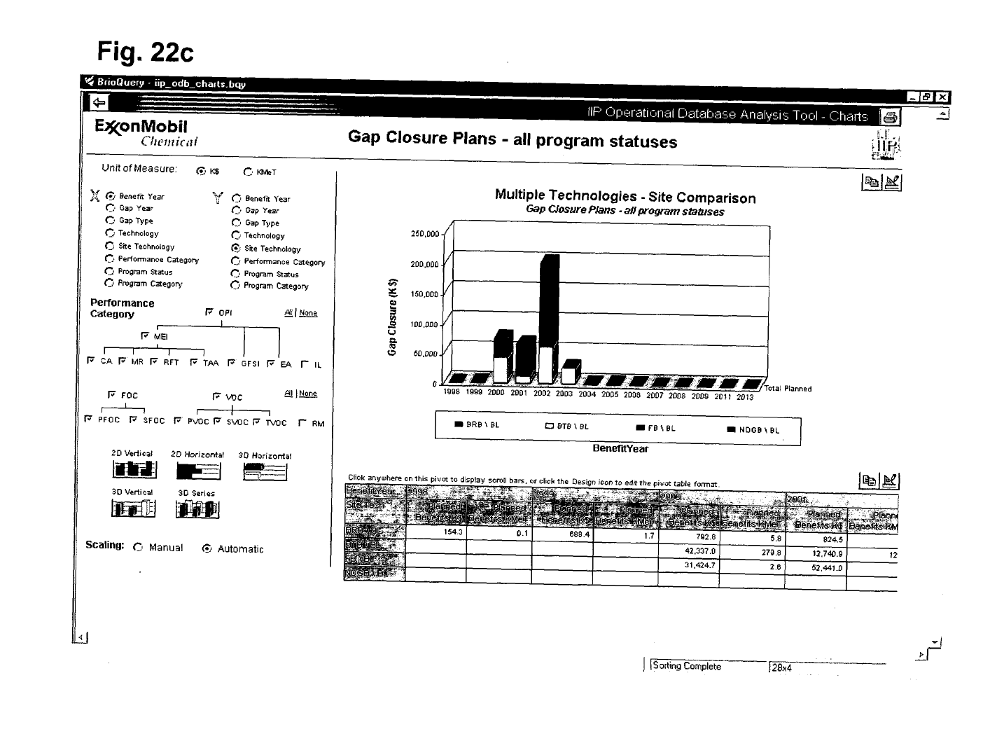

The charts and reports can be readily used to optimize the selection of desirable improvements to best make use of limited funds and resources. For example, FIG. 22a illustrates a screen shot of a criteria selection screen for a gap closure planned chart. In the illustrated screen, the various available plants have been selected and the gap closure plan chart has further been selected. As above, various performance categories can be selected or deselected as desired, as can units of measure. In the illustrated case, all of the available plants have been selected, but as above, the selection could be done based on business group or location as previously described. The screen shot of FIG. 22b illustrates a first result of the selection indicated in FIG. 22a. This is an indication of the gap closure plans for all program statuses over a period of years for each of the selected performance categories of the selected plants. It is noted that each particular performance category result is the summation of the category for each of the particular selected technologies, plants, or combination as selected. It is also noted that the particular chart can be illustrated with various X and Y axes, in this case with the unit of measure being a dollar amount as indicated in the selection screen of FIG. 22a and selectable in the chart. The changing of the axes can be done by changing the selected axes indicators on the left side of the indicated chart. For example, FIG. 22c indicates a change in the Y axis from performance category to site technology. In this case the bar chart indicates the gap closure plans by year by site technology, thus providing a very quick alternative view to that shown in FIG. 22b. As can be seen, the X and Y axes can be selected from benefit year, gap year, gap type, technology, site technology, performance category, program status or program category. In other situations, other values could be readily used. It is also understood that the criteria could be date limited by benefit or gap year or could be for particular gap types.

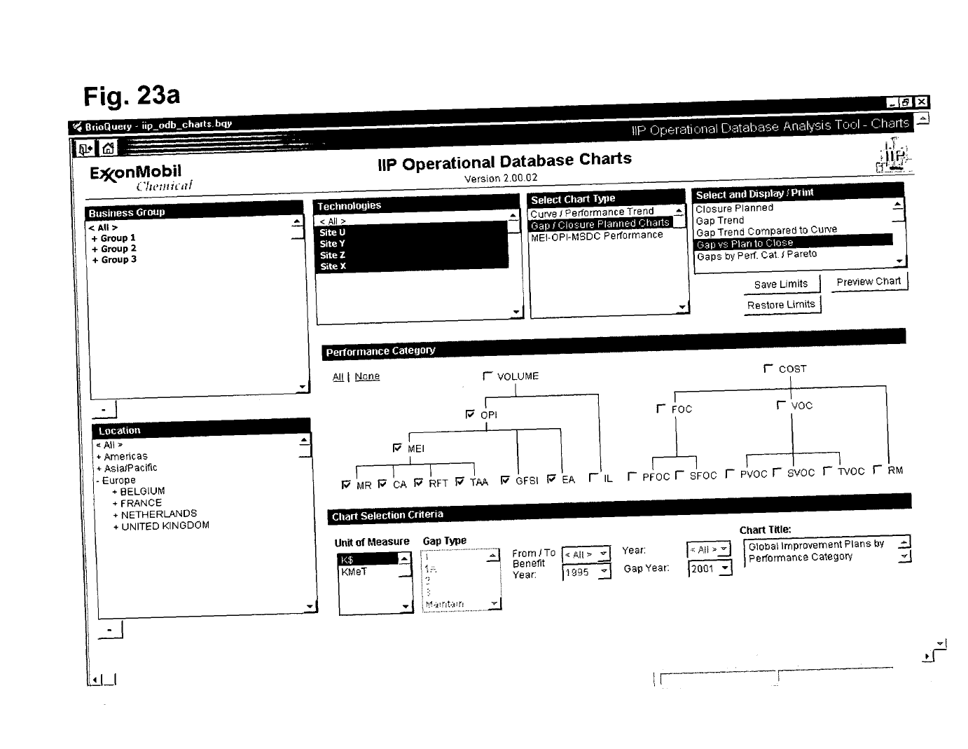

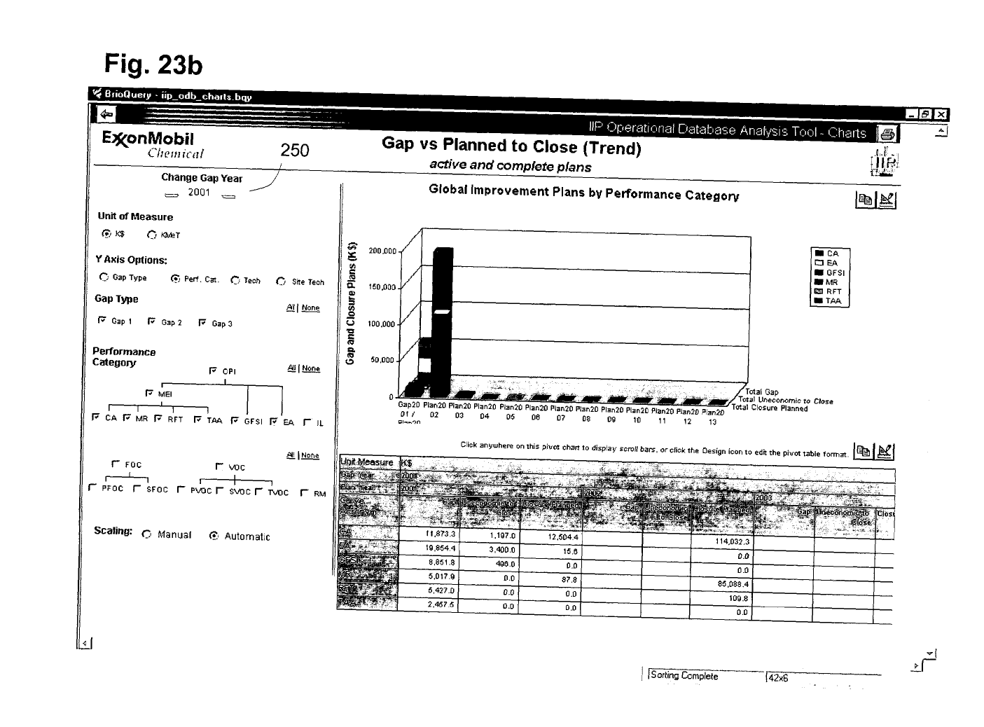

Alternatively, other charts can be provided, such as a gap versus plan to close chart. Selection criteria are selected as shown in FIG. 23a. In this case the particular selected display is a gap versus plan to close as opposed to the closure planned chart of FIG. 22a. The resulting chart is shown in FIG. 23b. The particular chart illustrated is for the gap year 2001 but this can be changed by selecting a button in a change gap year field 250. By scanning through the gap years, the planned gap closures could readily be seen for the selected plants, technologies, categories and so on. Again, the Y axis options can be changed and particular gap types to be utilized can be selected.

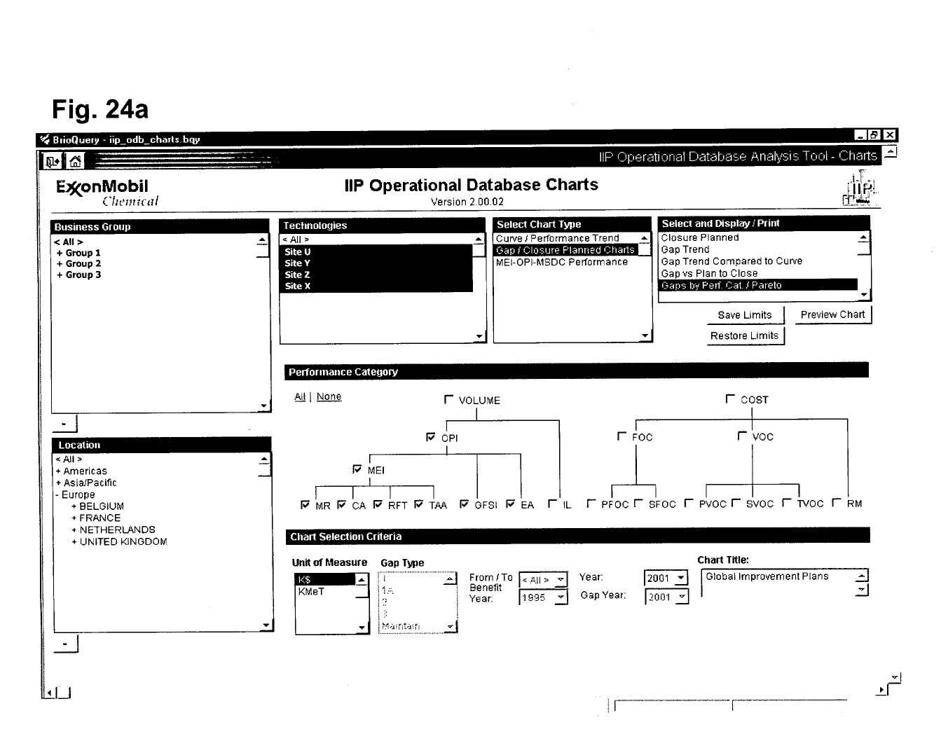

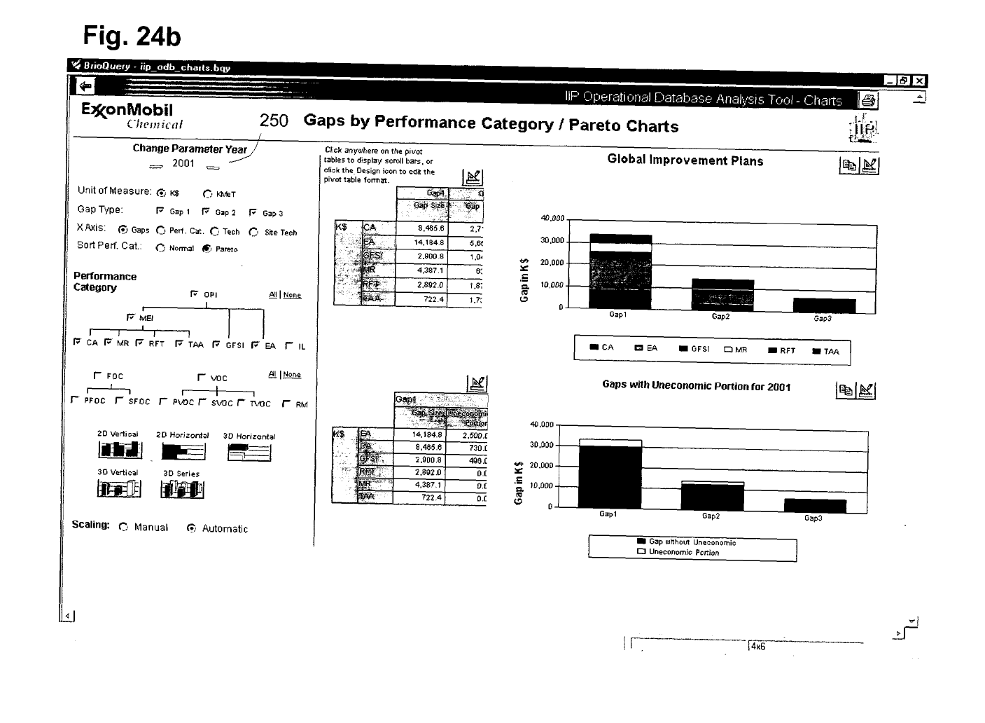

As mentioned above, in certain circumstances a Pareto chart can also be used to help improve data analysis. This is shown by a selection screen as in FIG. 24a and the resulting chart of FIG. 24b where a gap by performance category chart is shown in a Pareto chart format. Again, the year can be changed, as well as the X axis value in this case. By changing the options, rapid analysis can be performed.

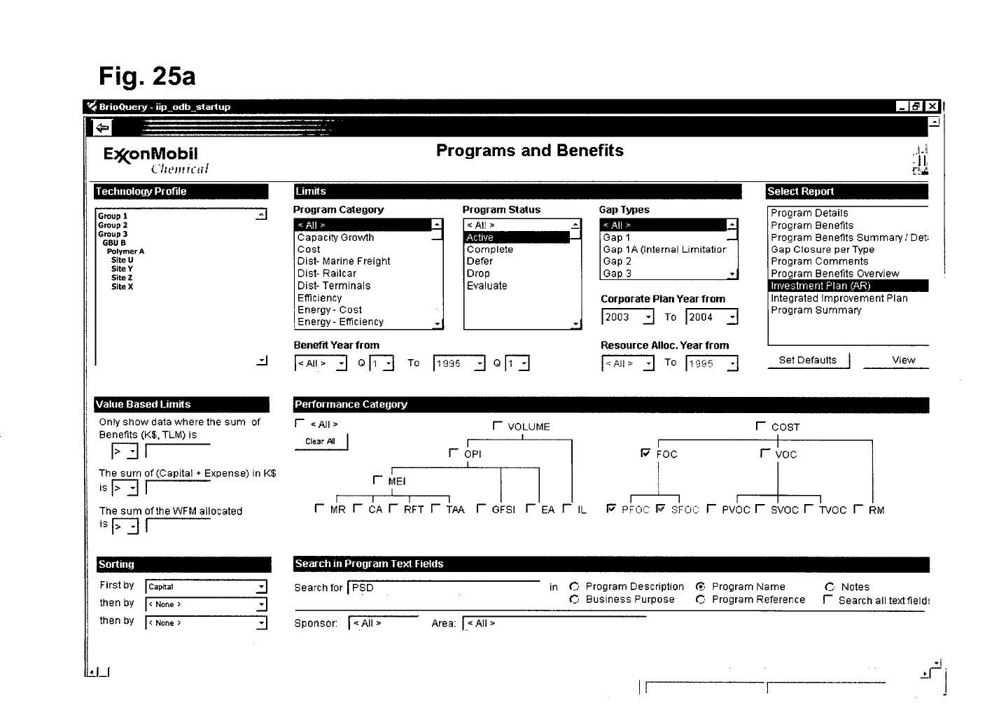

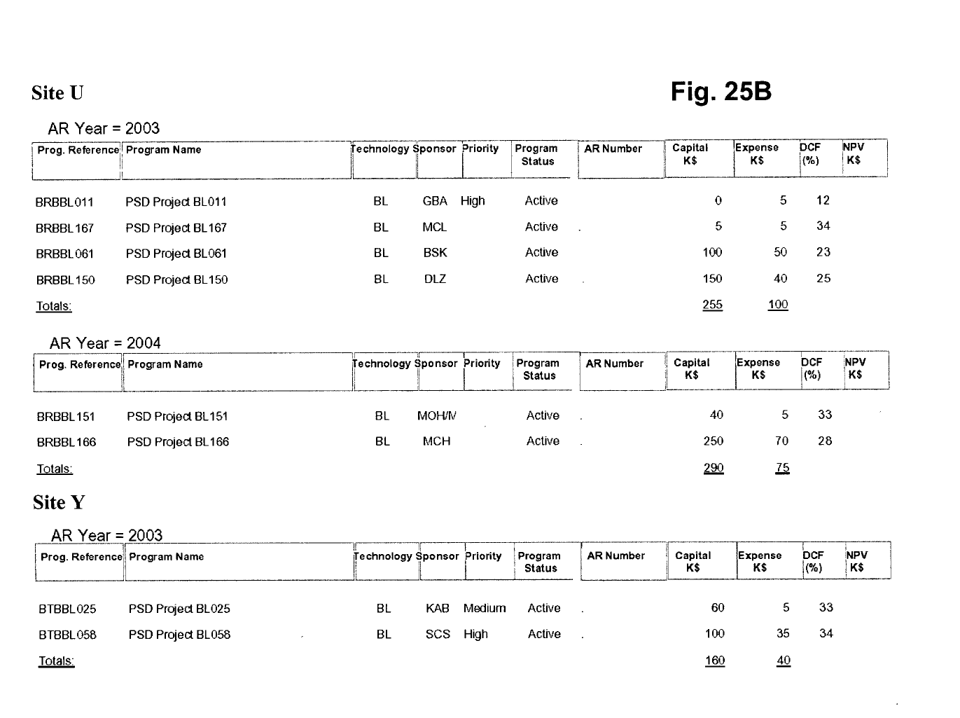

In addition to charts, reports are very helpful to analyze the data. To this end a tool according to the present invention preferably also provides various reports. Referring then to FIG. 25a, a selection screen is illustrated. In this case, the data may be, for instance, the technology of polymers, particularly Global Business Unit B (which may be, for instance, leadership polymers), and more particularly Polymer A (which may be, for instance, polystyrene). The selected technology profile is thus Polymer A for a series of selected plants as illustrated in FIG. 25a. In this case an investment plan report is selected with sorting done by plant, by year and then by capital expenditures required. The first page of the resulting report is shown in FIG. 25b. As can be seen, Site U in the year 2003 has four potential process improvement projects and these have been sorted in increasing capital dollars order. In this case all available dollar amounts have been selected, but as shown in FIG. 25a, lower limits to the graph can be selected to limit the data to larger valued projects, which would most affect any capital improvement plans. Any lower cost alternatives could be left to the discretion of the particular plant manager or group manager by providing a discretionary fund. While FIG. 25b is shown sorted by plant and by year, it could also readily be developed by year so that any capital intensive and/or expense intensive projects for a particular year could be shown in order, irrespective of plant technology or location.

While FIGS. 25a and 25b show a report based on capital expenditures, for optimal planning of an economic return it may be more appropriate to use a percentage discounted cash flow (% DCF). This allows an indication of project return rather than pure expenditures. This would be selected using the criteria screen shown in FIG. 25a, where a similar technology profile and report to FIGS. 24a and 24b are used, but in this case the final sorting criteria is DCF or discounted cash flow. The first page of the resulting report is shown in FIG. 25b, where the particular projects for each year of the report are shown with increasing discounted cash flow percentage. Thus data for each particular plant for each particular year is readily visible to quickly show which projects provide the best discounted cash flow analysis. When this has been done at varying levels and alternatively without grouping by plant, the most cost effective improvement projects could readily be determined.

From a strict accounting point of view it may be most appropriate to do this for all plants across all technology types around the globe to determine the projects providing the best return, but this may not necessarily be an optimal solution. Because of other corporate concerns it may be appropriate to provide some improvement expenditure for each of the particular technologies groups and/or locations. Thus, running the report at overall levels, at technology levels, at plant levels and various other levels would provide the most overall optimal solution, even though it may not provide the best numerical profit. This selection and sorting at various levels thus would allow other corporate objectives to be optimized at the same time.

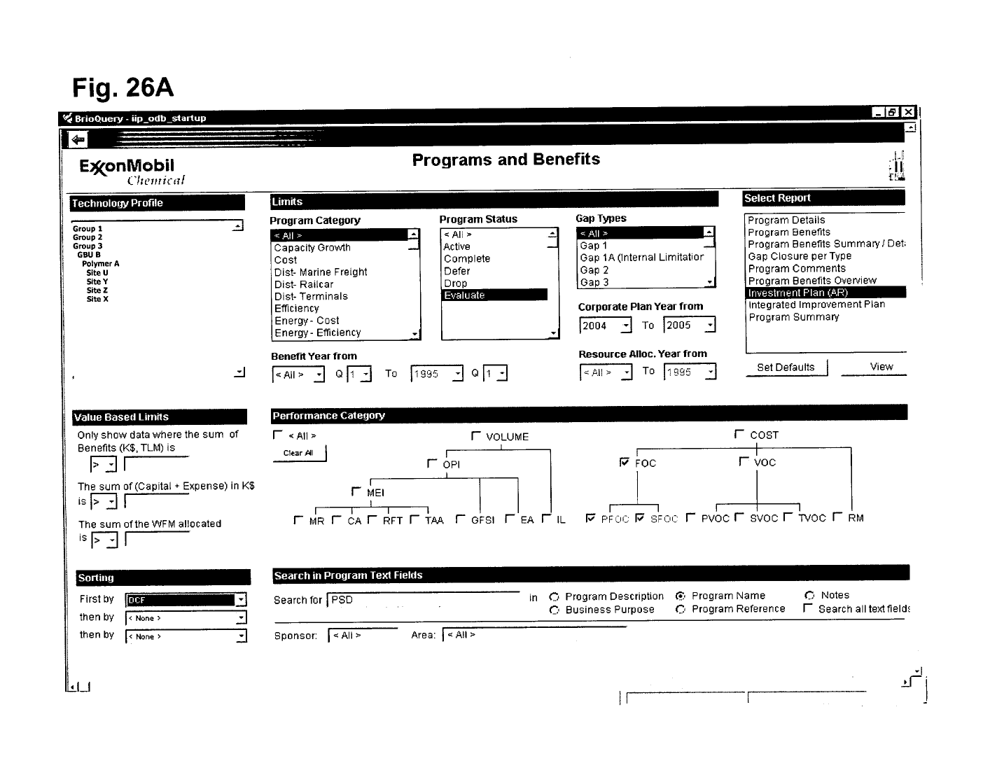

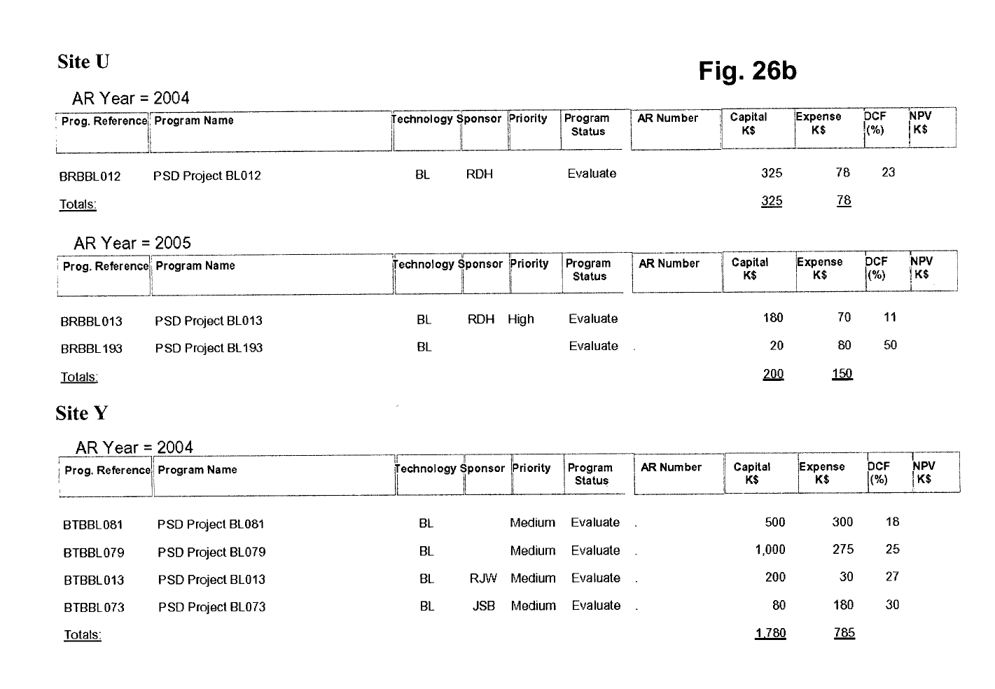

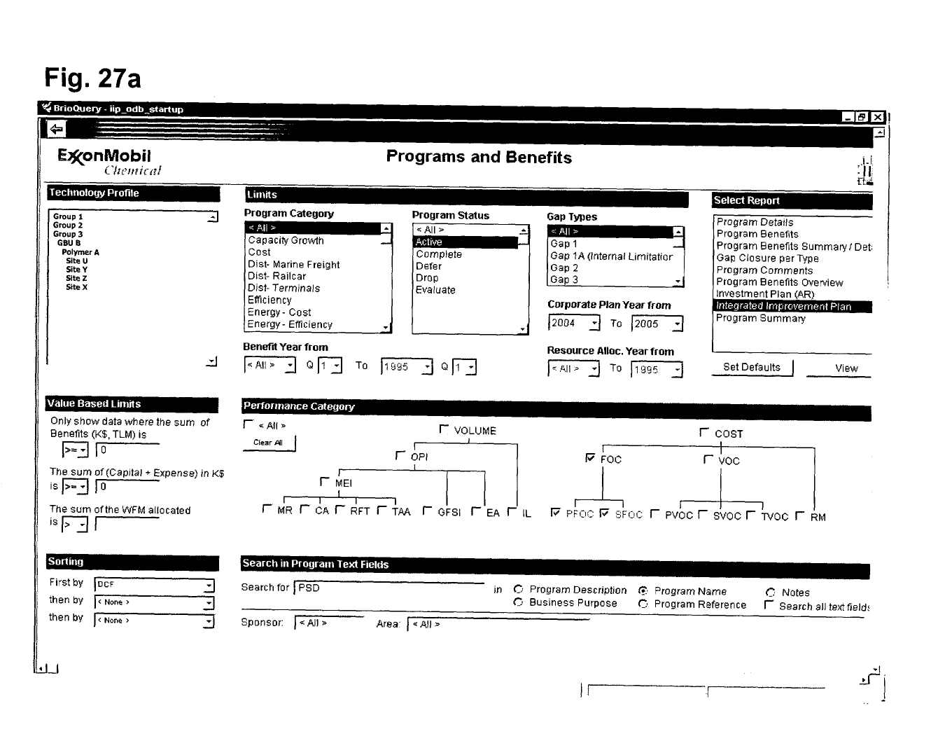

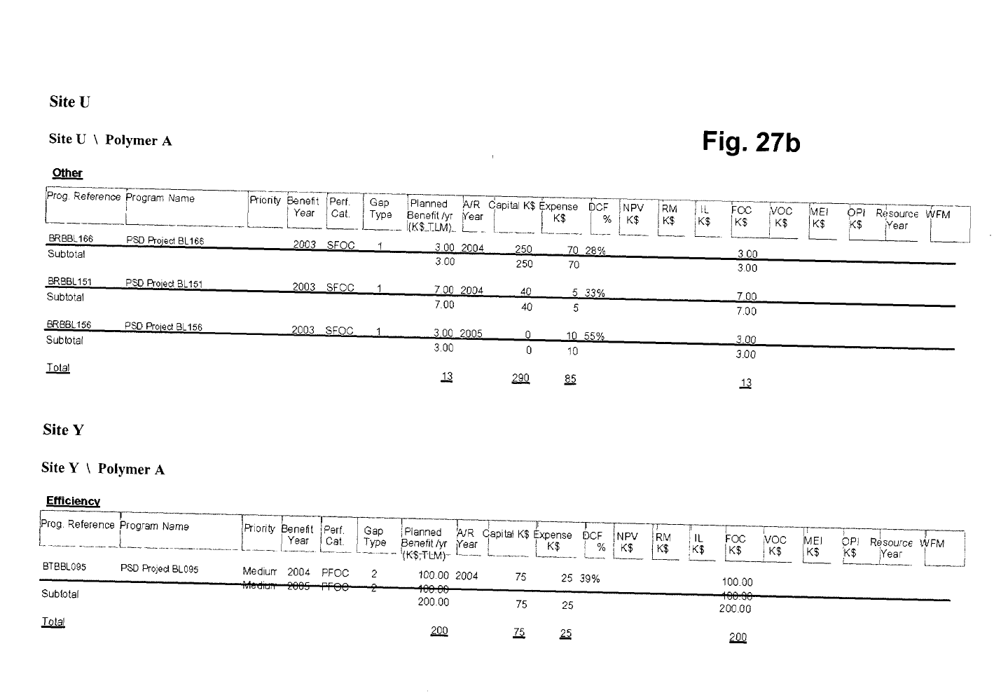

As shown in FIG. 27a, the selection criteria are modified to define a minimum dollar amount for benefits and costs, though in the example the value is zero. Additionally, a different report format has been selected and is shown in FIG. 27b. The results are sorted by plant and then by DCF and different items are shown, compared to FIG. 26b.

Thus, a tool to simplify a process improvement planning is shown. Data of the particular factors of each particular location is collected at a number of global sites. While individual plant, technology, or line data may have been analyzed on a local basis before, the collected global data is overwhelming and cannot be readily analyzed using the prior tools, yet overall company performance requires an optimal global solution. In a tool according to the preferred embodiment the data is entered locally and then provided and joined in a data warehouse to provide full global analysis capability. This global data is periodically used for management review and analysis. With all of the local global data thus gathered and organized, various tools and reports are provided for a larger and flexible review and operational data at the desired level, either across technologies, across locations, or a combination of both, down to a desired detail level can be rapidly obtained to allow greatly improved optimization planning.

A tool according to the present invention allows the technical problem of optimizing process improvements on a global basis to be performed. The varied data from around the world is collected using a series of user interfaces designed to maintain system security while at the same time providing flexibility to the user. The collected data is then analyzed and provided for review through user-friendly selection criteria. Various reports and charts provide a user interface to show the collected, selected data in condensed and detailed formats. Thus the tool allows analysis of process improvement data which could not previously be done because of the limitations in data collection and reporting not allowing user interfaces to be used at the global level as necessary for optimization in the current environment.

While the invention has been disclosed with respect to a limited number of embodiments, numerous modifications and variations will be appreciated by those skilled in the art. It is intended, therefore, that the appended claims cover all such modifications and variations that may fall within the true sprit and scope of the invention, which includes the following preferred embodiments: a system for collective process improvement optimization at a plurality of locations, each of the locations having processes and identified improvements and at least some of the locations including processes having common and disparate elements, the system comprising: data storage related to each location; a plurality of data entry systems, each data entry system to receive location data relevant to improvements to a location process from a user for a location and storing received location data in the related data storage for the location; collective data storage coupled to the data storage of each location for collectively storing all of the data received for each location; a collective data selection system to allow a user to select various data from the collectively stored data at varied detail levels; and a collective data visualization system to allow a user to view the selected data at the selected detail level in a plurality of formats to allow easy analysis of the data. Even more preferred embodiments, alone or in combination as would be apparent to one of ordinary skill in the art in possession of the present invention, include the aforementioned system: wherein the collective data storage includes (a) a data warehouse storing all of the data for each location; and (b) analysis data storage including a copy of all of the data for each location provided from the data warehouse; wherein the data storage related to each location is logically separated; further comprising a plurality of local data visualization systems, each local data visualization system to allow a user to view stored data for that location in a plurality of formats; wherein each local data entry system further includes a calculation entity to develop calculated data related to the location and stored in the related data storage for the location; wherein the process improvements for the plurality of locations can be organized in a plurality of ways and the collective data selection system allows selection using at least some of the plurality of ways, and especially wherein the collective data selection system allows selection using each of the plurality of ways, and/or wherein the locations are geographically dispersed and the processes are of a plurality of types, the types being organized at various levels of generality, and wherein the collective data selection system allows selection by geography and by process type, and even more especially wherein the geography and process type can be selected at various levels of generality, and yet even more especially wherein the type includes intermediates at the highest level of generality, includes fluids and synthetics at the next lower level of generality, and includes oxy fluids and hydrocarbon fluids and esters, low viscosity polyalphaolefins and high viscosity polyalphaolefins at the next lower level of generality, and/or wherein the geography includes Americas, Asia Pacific and Europe at the highest level of generality, and includes Sarnia, Beaumont, Baytown and Baton Rouge, Singapore; and Antwerp, Fawley and Rotterdam at the next lower level of generality; wherein the location process improvement data includes data over a series of time periods and for a series of improvement levels and wherein the data entry system receives data for each of the time periods and each of the improvement levels for the each process improvement; wherein the formats of the collective data visualization system include charts and reports, especially wherein a chart can be viewed using different selected data for an axis for a given set of selected data, and especially wherein a chart can be viewed using different selected data for each axis for a given set of selected data; wherein collective data visualization system can further select data sorting parameters for reports.

Another preferred embodiment is a method for collective process improvement optimization at a plurality of locations, each of the locations having processes and identified improvements and at least some of the locations including processes having common and disparate elements, the method comprising (i) receiving data relevant to improvements to a process from a plurality of data entry systems, each data entry system receiving location data relevant to improvements to a location process from a user for a location, (ii) storing received location data in data storage related to the location, (iii) collectively storing all of the data received for each location in collective data storage (iv) selecting various data from the collectively stored data at varied detail levels, and (v) viewing the selected data at the selected detail level in a plurality of formats to allow easy analysis of the data; and also more preferred embodiments, alone or in combination as would be apparent to one of skill in the art in possession of the present disclosure, including the aforementioned method wherein collectively storing includes (i) storing all of the data for each location in a data warehouse; and (ii) storing a copy of all of the data for each location provided from the data warehouse in analysis data storage; wherein the data storage related to each location is logically separated; the method further comprising viewing stored data for a location in a plurality of formats; the method further comprising developing calculated data related to the location and storing it in the related data storage for the location; the method wherein the process improvements for the plurality of locations can be organized in a plurality of ways and the collectively stored data can be selected using at least some of the plurality of ways, and more especially wherein the locations are geographically dispersed and the processes are of a plurality of types, the types being organized at various levels of generality, and wherein the collectively stored data can be selected by geography and by process type, and yet even more especially wherein the geography and process type can be selected at various levels of generality, and yet still more especially wherein the type includes intermediates at the highest level of generality, includes fluids and synthetics at the next lower level of generality, and includes oxy fluids and hydrocarbon fluids and esters, low viscosity polyalphaolefins and high viscosity polyalphaolefins at the next lower level of generality, and/or wherein the geography includes Americas, Asia Pacific and Europe at the highest level of generality, and includes Sarnia, Beaumont, Baytown and Baton Rouge, Singapore, and Antwerp, Fawley and Rotterdam at the next lower level of generality; the method wherein the location process improvement data includes data over a series of time periods and for a series of improvement levels and wherein the data entry system receives data for each of the time periods and each of the improvement levels for the each process improvement; the method wherein the plurality of formats for viewing collective data include charts and reports, and more especially wherein a chart can be viewed using different selected data for an axis for a given set of selected data and more especially wherein a chart can be viewed using different selected data for each axis for a given set of selected data, and/or wherein the user can further select data sorting parameters for reports; the method further comprising prioritizing identified improvements after selecting and viewing the collectively stored data; the method further comprising optimizing identified improvements after selecting and viewing the collectively stored data.

Finally, various tradenames used herein are indicated by a ™ indicating that the names may be protected by certain trademark rights. Some such names may also be registered trademarks in various jurisdictions.

1. A system for collective process improvement optimization at a plurality of locations, each of the locations having processes and identified improvements and at least some of the locations including processes having common and disparate elements, the system comprising:
data storage related to each location;
a plurality of data entry systems, each data entry system to receive location data relevant to improvements to a location process from a user for a location and storing received location data in the related data storage for the location;
collective data storage coupled to the data storage of each location for collectively storing all of the data received for each location;
a collective data selection system to allow a user to select various data from the collectively stored data at varied detail levels; and
a collective data visualization system to allow a user to view the selected data at the selected detail level in a plurality of formats to allow easy analysis of the data.

2. The system of claim 1, wherein the collective data storage includes:
a data warehouse storing all of the data for each location; and
analysis data storage including a copy of all of the data for each location provided from the data warehouse.

3. The system of claim 1, wherein the data storage related to each location is logically separated.

4. The system of claim 1, further comprising:
a plurality of local data visualization systems, each local data visualization system to allow a user to view stored data for that location in a plurality of formats.

5. The system of claim 1, wherein each local data entry system further includes a calculation entity to develop calculated data related to the location and stored in the related data storage for the location.

6. The system of claim 1, wherein the process improvements for the plurality of locations can be organized in a plurality of ways and the collective data selection system allows selection using at least some of the plurality of ways.

7. The system of claim 6, wherein the collective data selection system allows selection using each of the plurality of ways.

8. The system of claim 6, wherein the locations are geographically dispersed and the processes are of a plurality of types, the types being organized at various levels of generality, and wherein the collective data selection system allows selection by geography and by process type.

9. The system of claim 8, wherein the geography and process type can be selected at various levels of generality.

10. The system of claim 9, wherein the type includes intermediates at the highest level of generality; includes fluids and synthetics at the next lower level of generality; and includes oxy fluids and hydrocarbon fluids and esters, low viscosity polyalphaolefins and high viscosity polyalphaolefins at the next lower level of generality.

11. The system of claim 9, wherein the geography includes Americas, Asia Pacific and Europe at the highest level of generality; and includes Sarnia, Beaumont, Baytown and Baton Rouge; Singapore; and Antwerp, Fawley and Rotterdam at the next lower level of generality.

12. The system of claim 1, wherein the location process improvement data includes data over a series of time periods and for a series of improvement levels and wherein the data entry system receives data for each of the time periods and each of the improvement levels for the each process improvement.

13. The system of claim 1, wherein the formats of the collective data visualization system include charts and reports.

14. The system of claim 13, wherein a chart can be viewed using different selected data for an axis for a given set of selected data.

15. The system of claim 13, wherein collective data visualization system can further select data sorting parameters for reports.

16. A method for collective process improvement optimization at a plurality of locations, each of the locations having processes and identified improvements and at least some of the locations including processes having common and disparate elements, the method comprising:
receiving data relevant to improvements to a process from a plurality of data entry systems, each data entry system receiving location data relevant to improvements to a location process from a user for a location;
storing received location data in data storage related to the location;
collectively storing all of the data received for each location in collective data storage;
selecting various data from the collectively stored data at varied detail levels; and
viewing the selected data at the selected detail level in a plurality of formats to allow easy analysis of the data.

17. The method of claim 16, wherein collectively storing includes:
storing all of the data for each location in a data warehouse; and
storing a copy of all of the data for each location provided from the data warehouse in analysis data storage.

18. The method of claim 16, wherein the data storage related to each location is logically separated.

19. The method of claim 16, further comprising:
viewing stored data for a location in a plurality of formats.

20. The method of claim 16, further comprising:
developing calculated data related to the location and storing it in the related data storage for the location.

21. The method of claim 16, wherein the process improvements for the plurality of locations can be organized in a plurality of ways and the collectively stored data can be selected using at least some of the plurality of ways.

22. The method of claim 21, wherein the locations are geographically dispersed and the processes are of a plurality of types, the types being organized at various levels of generality, and wherein the collectively stored data can be selected by geography and by process type.

23. The method of claim 22, wherein the geography and process type can be selected at various levels of generality.

24. The method of claim 23, wherein the type includes intermediates at the highest level of generality; includes fluids and synthetics at the next lower level of generality; and includes oxy fluids and hydrocarbon fluids and esters, low viscosity polyalphaolefins and high viscosity polyalphaolefins at the next lower level of generality.

25. The method of claim 23, wherein the geography includes Americas, Asia Pacific and Europe at the highest level of generality; and includes Sarnia, Beaumont, Baytown and Baton Rouge; Singapore; and Antwerp, Fawley and Rotterdam at the next lower level of generality.

26. The method of claim 16, wherein the location process improvement data includes data over a series of time periods and for a series of improvement levels and wherein the data entry system receives data for each of the time periods and each of the improvement levels for the each process improvement.

27. The method of claim 16, wherein the plurality of formats for viewing collective data include charts and reports.

28. The method of claim 27, wherein a chart can be viewed using different selected data for an axis for a given set of selected data.

29. The method of claim 27, wherein the user can further select data sorting parameters for reports.

30. The method of claim 16, further comprising:
prioritizing identified improvements after selecting and viewing the collectively stored data.

31. The method of claim 16, further comprising:
optimizing identified improvements after selecting and viewing the collectively stored data.
